(19) United States
(12) Patent Application Publication
(10) Pub. No.: US 2026/0113517 A1
(43) Pub. Date: Apr. 23, 2026

(54) System and Method for Real-Time Creation and Streaming of Customized Videos

(71) Applicant: Infuse Video Inc., Wilmington, DE (US)

(72) Inventors: Ismael Carlos Garrido Friss DE KEREKI, Wilmington, DE (US); Rudolph Eustachius Alphons Philip VAN DER LINDEN, Wilmington, DE (US)

(21) Appl. No.: 19/366,573

(22) Filed: Oct. 23, 2025

Related U.S. Application Data
(60) Provisional application No. 63/710,617, filed on Oct. 23, 2024.

(51) Int. Cl. H04N 21/854

(52) U.S. Cl. CPC H04N 21/854

(57) ABSTRACT

A system and method for real-time creation and streaming of customized videos are disclosed. The system comprises a decision engine that processes user requests and/or session ID requests containing data parameters to generate an Edit Decision List (EDL) specifying a sequence of personalized media components. Media is represented through a multi-layer composition model combining pre-rendered content, reusable canonical segments, and intermediate layers with viewer-specific overlays or live data sources. A rendering module generates dynamic video segments in real-time, incorporating live data such as weather updates or location information. A streaming core translates the EDL into instructions for assembling a coherent video stream, stitching together pre-rendered content and dynamically generated elements. Edge workers at Content Delivery Network (CDN) nodes adjust Presentation Time Stamps (PTS) and Decoding Time Stamps (DTS) of video segments, whether cached or uncached, combining them into a seamless playback experience. The system dynamically selects between client-side and server-side rendering based on real time assessment of client capabilities and network conditions, and mixes different rendering strategies within a single video stream. Just-in-time transcoding ensures frame-accurate cuts and smooth transitions between segments. The system as described herein enables highly personalized, efficient, and scalable delivery of customized video content across various use cases and protocols.

### FIELD OF THE INVENTION

The present invention is to a system and method for implementing and operating multimedia content delivery systems, and in particular to such systems and methods for real-time creation, rendering, and streaming of customized videos.

### BACKGROUND OF THE INVENTION

The proliferation of digital media and streaming services has led to an increasing demand for personalized and dynamic video content. Traditional video streaming methods rely on pre-rendered videos stored on servers and delivered to users upon request. However, this approach poses significant limitations in terms of scalability, personalization, and efficient use of network resources.

Existing systems often struggle to deliver customized content in real-time due to constraints in rendering capabilities and network latency. The challenge of creating truly personalized video experiences is compounded by the need to adapt content for various devices, network conditions, and user preferences. Additionally, delivering unique content to each user can lead to inefficiencies in Content Delivery Network (CDN) caching, as personalized content cannot be easily reused across multiple requests, resulting in lower cache effectiveness and slower delivery times.

Previous attempts to address these challenges have focused on splicing pre-existing content or performing limited on-demand editing during transcoding. For example, some systems allow for the insertion of advertisements or local programming into digital video transport streams. Others provide methods for on-demand video editing at transcode-time in video streaming systems. However, these solutions often lack the flexibility and sophistication required for truly dynamic, personalized content creation and delivery.

Furthermore, existing systems typically struggle with balancing the computational load between client devices and servers. This can result in either overburdened servers or poor performance on less capable client devices. The challenge of efficiently distributing rendering tasks while maintaining high-quality, personalized video experiences remains largely unresolved.

Another significant limitation of current systems is their inability to efficiently incorporate real-time data, such as live weather updates, location information, or current promotional offers, into personalized video streams. This restricts the level of relevance and timeliness that can be achieved in personalized content.

There is a clear need for a more advanced system that can efficiently generate and stream personalized video content in real-time while maximizing CDN cache efficiency, minimizing latency, and providing a seamless, high-quality viewing experience across a wide range of devices and network conditions. Such a system would need to intelligently balance client-side and server-side processing, incorporate live data seamlessly, and provide flexible rendering options to meet the diverse needs of modern video content delivery.

### BRIEF SUMMARY OF THE INVENTION

The present invention overcomes the drawbacks of the background art by providing a novel approach to real-time creation and streaming of customized videos, leveraging advanced decision-making algorithms, dynamic rendering techniques, and intelligent caching strategies to deliver highly personalized content efficiently and at scale.

The present invention provides a flexible approach to content delivery, in that it is operative to create the customized videos at an origin server, and/or through edge computing, CDNs, or any other suitable type of distributed computing.

The present invention, in at least some embodiments, provides a system and method for real-time creation and streaming of customized videos. The system comprises an origin server that processes incoming user requests containing data parameters. Based on these parameters, a decision engine selects relevant video segments from a repository using a meta data-matching system, or another type of system such as a generative AI based or predictive AI based system (which could for example analyze these segments according to their meta-data or their content, for example). Such a meta data-matching system may comprise a tag-matching system, for example. Some segments may require real-time generation using tools like FFmpeg or game engines such as Unity, incorporating dynamic data such as live weather updates, location information, or current special offers.

Once the necessary video segments are selected and generated, the system initiates a streaming session using HTTP Live Streaming (HLS) or Dynamic Adaptive Streaming over HTTP (DASH) protocols, for example. Edge workers located at CDN nodes may modify and stitch the video segments together by adjusting Presentation Time Stamps (PTS) and Decoding Time Stamps (DTS), and/or through transcoding, ensuring a seamless playback experience for the end-user. This method allows for segments to be cached and reused across different requests, significantly improving CDN cache efficiency. Optionally such modification and stitching together of content is performed at the origin server, or on a combination of edge workers and origin server.

The present invention differs from the background art in a number of ways. For example, in regard to US20020196850 (Splicing of digital video transport streams), the description focuses primarily on splicing advertisements or local programming into a digital video transport stream. While it addresses some similar challenges, such as maintaining continuity of timing references and adjusting presentation time stamps, the present invention in various embodiments provides significant additional functionality. The present invention provides real-time personalization and dynamic content generation, or even creation from scratch, not just splicing of pre-existing content. In at least some embodiment, the system as described herein uses a sophisticated decision engine that considers user profile information for content selection. Furthermore, the system may incorporate edge computing and CDN caching strategies, alone or inn combination, for improved efficiency and scalability. The system may also feature multi-protocol support and adaptive bitrate streaming, which are not addressed in the background art.

In regard to U.S. Pat. No. 11,924,482 (Method for on-demand video editing at transcode-time in a video streaming system), the present invention in at least some embodiments incorporates a more advanced decision engine that can utilize AI and machine learning for content selection. The system as described herein may provide more sophisticated rendering capabilities, including the use of game engines for real-time content generation. The present invention in at least some embodiments offers a hybrid approach to rendering, dynamically deciding between client-side and server-side processing. Each frame of the video may potentially have a different origin—from the origin server, CDN and so forth—and may still be combined to create a single playlist or program of content. Optionally, the system may implement a more advanced caching strategy at the CDN level, allowing for efficient reuse of video segments.

In regard to U.S. Pat. No. 11,924,483 (Method for on-demand video editing at transcode-time in a video streaming system), the present invention in at least some embodiments differs as for the previously described U.S. Pat. No. 11,924,482. Additionally, the system as described herein provides more advanced personalization capabilities, including the ability to incorporate real-time data such as weather or location information. The system may also offer more flexible content insertion options, including the ability to dynamically generate entire segments rather than just modifying existing ones.

In regard to U.S. Pat. No. 9,491,499 (Dynamic stitching module and protocol for personalized and targeted content streaming), the present invention in at least some embodiments provides more sophisticated real-time rendering capabilities, as noted above, including the server-side rendering of content, as well as a more advanced caching strategy that allows for efficient reuse of video segments across different contexts.

Indeed the present invention, in at least some embodiments, is able to perform not just “on demand” video generation, but is also able to create “on-the-fly adapting on-demand” or “live” content, where a decision engine makes new decisions, which optionally results in a new and unique video stream which may include wholly new video and audio segments on the fly.

In at least some embodiments, the present invention incorporates edge computing more extensively, allowing for more efficient processing and lower latency. The present invention may also provide more flexible options for content personalization, including the ability to dynamically generate or modify entire segments based on user data.

Although the background art addresses some aspects of personalized video streaming and content insertion, the present invention provides a more comprehensive, flexible, and technologically advanced solution. It incorporates real-time rendering, sophisticated decision-making, advanced caching strategies, and edge computing to deliver highly personalized content with greater efficiency and scalability.

In at least some embodiments, the system may employ a default caching policy wherein all generated intermediate layers are cached upon creation, regardless of predicted reuse. This conservative approach ensures high cache hit rates and consistent low-latency performance, providing a reliable baseline for system operation. The default caching policy may be supplemented or replaced with selective caching as operational data accumulates and reuse prediction models achieve sufficient accuracy. The transition from universal caching to selective caching may occur gradually, beginning with high-confidence predictions (e.g., caching only intermediates predicted with >95% confidence to achieve high reuse) and expanding the selective regime as model performance improves. Without wishing to be limited in any way, this phased approach minimizes risk of performance degradation while progressively improving resource efficiency.

According to at least some embodiments, there is provided a system for real-time creation and streaming of customized videos, comprising: a decision engine configured to: receive a request containing data parameters or contextual inputs, which may include encrypted or otherwise protected values; analyze the data parameters or contextual inputs to determine relevant video segments; generate an Edit Decision List (EDL) specifying a sequence of media components tailored to the request; a rendering module configured to: generate dynamic video segments in real-time based on the EDL; incorporate live data into the dynamic video segments; a streaming core configured to: translate the EDL into instructions for assembling a video stream; stitch together pre-rendered content and dynamically generated elements into a coherent video stream; edge workers located at Content Delivery Network (CDN) nodes, configured to: adjust Presentation Time Stamps (PTS) and Decoding Time Stamps (DTS) of cached video segments; combine adjusted video segments into a seamless playback experience; and wherein the system is configured to: select between client-side and server-side rendering based on real-time assessment of client capabilities and network conditions; and dynamically mix rendering strategies within a single video stream.

Optionally, the rendering module is further configured to utilize multiple rendering tools, including transcoders and game engines, to generate dynamic video segments.

Optionally, the live data incorporated into dynamic video segments includes at least one of: weather updates, location information, and current promotional offers.

Optionally, the system further comprises a caching mechanism configured to: store video segments at CDN nodes; enable reuse of common elements across multiple requests; reduce redundant processing and minimize latency.

Optionally, the system is further configured to perform just-in-time transcoding to ensure frame-accurate cuts and smooth transitions between segments.

Optionally, the decision engine is further configured to apply artificial intelligence-driven decision-making processes to determine relevant video segments.

According to at least some embodiments, there is provided a method for real-time creation and streaming of customized videos, comprising: receiving a user request or a session (ID) request containing data parameters, which may include encrypted or otherwise protected values; analyzing the data parameters to determine relevant video segments; generating an Edit Decision List (EDL) specifying a sequence of media components tailored to the request; generating dynamic video segments in real-time based on the EDL, including incorporating live data into the dynamic video segments; translating the EDL into instructions for assembling a video stream; stitching together pre-rendered content and dynamically generated elements into a coherent video stream; wherein at Content Delivery Network (CDN) nodes the method comprise performing: adjusting Presentation Time Stamps (PTS) and Decoding Time Stamps (DTS) of cached video segments; combining adjusted video segments into a seamless playback experience; selecting between client-side and server-side rendering, or both, based on real-time assessment of client capabilities and network conditions; dynamically mixing rendering strategies within a single video stream.

Optionally the method further comprises utilizing multiple rendering tools, including transcoders and game engines, to generate dynamic video segments. Optionally the live data incorporated into dynamic video segments includes at least one of: weather updates, location information, and current promotional offers. Optionally the method further comprises storing video segments at CDN nodes; enabling reuse of common elements across multiple requests; and reducing redundant processing and minimizing latency.

Optionally the method further comprises performing just-in-time transcoding to ensure frame-accurate cuts and smooth transitions between segments. Optionally the method further comprises applying artificial intelligence-driven decision-making processes to determine relevant video segments.

According to at least some embodiments, there is provided a non-transitory computer-readable storage medium storing instructions that, when executed by a processor, cause the processor to perform the method as described herein.

According to at least some embodiments, there is provided a system for real-time creation and streaming of customized videos, comprising: a decision engine configured to generate an Edit Decision List (EDL) based on user request parameters and/or parameters received from a session (ID) request; a rendering module configured to generate dynamic video segments in real-time; a streaming core configured to assemble a coherent video stream; edge workers configured to adjust timestamps of cached video segments; and wherein the system is configured to: dynamically select between client-side and server-side rendering, or a hybrid thereof; mix different rendering strategies within a single video stream; incorporate live data into dynamic video segments; and perform just-in-time transcoding for frame-accurate cuts and transitions.

Optionally the decision engine is further configured to apply artificial intelligence-driven decision-making processes to generate the EDL.

According to at least some embodiments, there is provided a method performed at a Content Delivery Network (CDN) edge node for assembling a media stream, the method comprising: receiving, at the CDN edge node, a request for a media segment at a playlist position k having a presentation time associated with a previously emitted segment; retrieving, from a cache, a canonical media segment encoded without dependence on playlist position; computing a presentation-time offset Δ as a function of the playlist position k and of the presentation time associated with the previously emitted segment; rewriting, without decoding and re-encoding the entire segment, presentation time stamps (PTS) and decoding time stamps (DTS) of the canonical media segment by the offset Δ and, when an access unit preceding a key frame would otherwise result, transcoding only frames up to a next key frame; and emitting the rewritten media segment toward a user device; whereby a single cached rendition of the canonical media segment is reused across multiple playlist positions and bitrate variants.

According to at least some embodiments, there is provided a system for hybrid server-client rendering of personalized media, comprising: a decision engine configured to generate an Edit Decision List (EDL) for a requested program; a streaming core configured to translate the EDL into assembly instructions for segments; a server-side rendering module and a client-side rendering module; and a metadata generator configured to produce a rendering-metadata stream comprising frame-accurate instructions for overlays, compositions, or effects; wherein the system is configured to output (i) rendered video segments and (ii) the rendering-metadata stream to a user device, and to select, per segment, whether rendering is performed server-side, client-side, or in combination, based on detected device capabilities and network conditions.

According to at least some embodiments, there is provided a method for per-segment orchestration of rendering and delivery strategies, comprising: measuring device capabilities and network conditions for a session; selecting, for each segment of a program, a strategy from a set comprising: pre-transcoded delivery with timestamp adjustment, just-in-time (JIT) transcode, server-side render, client-side overlay render under metadata control, or a hybrid thereof; applying the selected strategy subject to a latency budget and quality constraints while minimizing an objective function comprising at least one of: accumulated latency, compute cost, and energy consumption; and persisting the selection outcome and observed playback metrics for feedback to subsequent selections.

Optionally rewriting the presentation time stamps and decoding time stamps preserves segment boundaries aligned across bitrate renditions of a common adaptive bitrate ladder. Optionally the method further comprises transmuxing, at the CDN edge node, between container formats and/or streaming protocols while maintaining the rewritten presentation time stamps and decoding time stamps.

Optionally the rendering-metadata stream includes one or more fields indicating required compute capabilities for client-side execution, and wherein a scheduler selects a rendering location or instance type based at least in part on the indicated capabilities.

Optionally the streaming core emits a server-generated intermediate render comprising a subset of layers of the program and the client-side rendering module composes a personalized overlay layer on top of the intermediate render according to the rendering-metadata stream.

Optionally the server transmits a rendering-metadata stream and associated assets enabling full or partial rendering of segments entirely on the client device.

Optionally the persisted playback metrics include scene- or element-level consumption data and the selecting comprises biasing future selections based on the persisted playback metrics.

Optionally the system automatically updates one or more selection policies, weighting functions, or model parameters based on the persisted playback metrics, thereby continuously optimizing subsequent rendering and delivery strategies across playback sessions.

Optionally the persisted playback metrics comprise at least one of: latency, rebuffering events, frame-drop rate, rendering time, network volatility, and device performance characteristics. Optionally the telemetry data further comprises user-level or aggregate engagement information, including completion rate, click-through rate, conversion, or dwell time, and wherein the optimization adjusts rendering and delivery strategies to improve at least one business objective selected from engagement, conversion, retention, or cost efficiency.

Optionally the telemetry system operates as a feedback loop for multi-objective optimization that balances technical performance metrics with business-level goals, the optimization being executed automatically by the orchestration engine using accumulated historical data.

Optionally telemetry collected during playback automatically updates at least one of (i) orchestration policies that select per-segment rendering and delivery strategies and (ii) cache management parameters including reuse-prediction thresholds, cache placement and eviction priority, thereby forming a closed feedback loop that continuously adapts subsequent sessions without requiring manual configuration.

Optionally the selecting comprises weighting sustainability metrics including energy cost and carbon intensity of available power sources together with device thermal or battery constraints, so as to reduce environmental impact while satisfying latency and quality targets.

Optionally the decision engine selects media segments based at least in part on structured external data sources accessed via secure interfaces, the structured data comprising one or more of user, contextual, or business data used to parameterize the Edit Decision List.

Optionally the program comprises multiple server-side intermediate layers at differing personalization granularities and a client-side layer, and wherein cached intermediates are managed hierarchically such that variants common to larger audiences are preferentially cached relative to finer-grained variants while allowing final per-viewer personalization at the client.

Optionally storing identifiers and hashes comprises:
computing a hash value for each intermediate video layer using a hash function selected to minimize collision probability;
indexing the intermediate video layer in storage using the computed hash value as a key; and
wherein the hash value is computed from at least one of: rendering parameters specified in the Edit Decision List, encoded video stream data of the intermediate layer, or raw rendered content before encoding.

Optionally cache invalidation operates through lazy evaluation, such that changed inputs produce non-matching hash values during cache lookup rather than through active purge operations; and
cached intermediate video layers persist according to time-to-live (TTL) policies independent of whether corresponding Edit Decision List inputs have changed.

Optionally the rendering module is configured to perform both temporal stitching of video segments and spatial compositing of overlay elements atop base video content;
temporal stitching combines video segments sequentially along a timeline; and
spatial compositing combines multiple visual or audio layers at overlapping time positions using programmable operations including alpha blending, chroma keying, or other compositing modes.

Optionally the system dynamically selects between server-side compositing and client-side compositing based on at least one factor selected from: client device GPU capabilities, content licensing requirements, network bandwidth conditions, thermal or power constraints of the client device, and degree of personalization required.

Optionally the system further comprises a prediction module configured to:
estimate a reuse likelihood for intermediate video layers based on Edit Decision List parameters and historical usage patterns; and
determine whether to generate and cache an intermediate layer or render content on-demand based on the estimated reuse likelihood exceeding a threshold.

Optionally the prediction module employs a machine learning model trained on features comprising at least one of: EDL complexity, rendering computational cost, historical request frequency, user population characteristics, content lifecycle attributes, or cache performance metrics.

Optionally the system is further configured to: track hash values of intermediate video layers previously presented to each user; and bias selection of intermediate variants toward those not previously viewed by a requesting user to prevent repetition.

Optionally the decision engine is configured to automatically determine, for each intermediate video layer, whether to generate and cache the intermediate layer or render content on-demand per request, based on predicted reuse analysis that estimates request frequency for the intermediate layer.

Optionally base, intermediate, and overlay layers may be composited into a single adaptive streaming output compliant with standard streaming protocols, such that pre-rendered content and dynamically rendered elements are interleaved within a unified manifest or playlist while preserving synchronization metadata for bitrate switching.

Optionally the method further comprises compositing multiple rendering layers into one adaptive streaming sequence compliant with standard streaming protocols, and intermixing pre-rendered and dynamically generated segments within a unified manifest or playlist according to synchronization metadata and adaptive-bitrate rules.

Optionally selected per-segment strategies may emit segments under a single adaptive streaming manifest or playlist compliant with standard streaming protocols that preserves segment-boundary alignment across bitrate renditions while interleaving pre-rendered and dynamically rendered segments in the same program timeline.

As used herein, ‘stitching’ or ‘temporal stitching’ refers to the sequential combination of video segments along the timeline, wherein segments are placed end-to-end to create a continuous video program whose duration is the sum of constituent segment durations. ‘Compositing,’ ‘spatial compositing,’ or ‘overlay rendering’ refers to the combination of multiple visual or audio layers at the same or overlapping temporal positions, wherein elements are layered atop base video content to create composite frames. A single video program may employ both temporal stitching (to combine segments) and spatial compositing (to add overlays to those segments).

As used herein, an ‘ABR ladder’ (adaptive bitrate ladder) or ‘encoding ladder’ refers to a set of multiple encoded renditions of the same video content at different quality levels, typically varying in resolution (e.g., 1080p, 720p, 480p) and bitrate (e.g., 6 Mbps, 3 Mbps, 1.5 Mbps). During adaptive bitrate streaming, the client device dynamically selects among these renditions based on available network bandwidth and device capabilities, switching between quality levels to optimize playback quality while avoiding rebuffering. Segment boundaries aligned across all renditions in the ladder, meaning that segments representing the same temporal range exist at each quality level, enabling seamless quality switching at segment boundaries.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions. The processor is configured to execute a predefined set of operations in response to receiving a corresponding instruction selected from a predefined native instruction set of codes.

Software (e.g., an application, computer instructions) which is configured to perform (or cause to be performed) certain functionality may also be referred to as a “module” for performing that functionality, and also may be referred to a “processor” for performing such functionality. Thus, processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions-which can be a set of instructions, an application, software-which are operable on a computational device (e.g., a processor) to cause the computational device to conduct and/or achieve one or more specific functionality. Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIG. 1 illustrates an exemplary overview of the system architecture for real-time creation and streaming of customized videos;

FIG. 2 depicts an exemplary workflow of processing a user request and the selection of video segments;

FIG. 3 shows an exemplary process of real-time generation of video segments using rendering tools;

FIG. 4 outlines an exemplary stitching and streaming process via workers;

FIG. 5 demonstrates an exemplary caching mechanism and reuse of video segments across multiple requests;

FIG. 6 shows a partial system overview containing a more detailed version of the decision process (also featured in FIG. 2), combined with a scenario where stitching is applied and selection and rendering of video and audio segments is performed in intermediary components; and

FIG. 7 shows an alternative, exemplary embodiment of the process of generation of Dynamic Segments.

### DESCRIPTION OF AT LEAST SOME EMBODIMENTS

The present invention provides a system and method for real-time creation and streaming of customized videos. At its core, the invention addresses the growing demand for personalized video content by introducing a novel approach to dynamically generate, render, and deliver tailored video experiences to users. Without wishing to be limited by a closed list, this system overcomes traditional limitations in scalability, latency, and content personalization that have plagued existing solutions.

The present invention, in at least some embodiments, comprises a sophisticated backend architecture that includes three primary components: a Decisioning Core, a Streaming Core, and a Rendering Core. These components work in concert to process user requests, select appropriate video segments, generate dynamic content when necessary, and seamlessly deliver a personalized video stream to the end-user. By leveraging edge computing and content delivery networks (CDNs), the system ensures efficient and low-latency delivery of customized content at scale.

The system preferably features the Decisioning Core, which analyzes incoming user requests containing data parameters or contextual inputs, which may include encrypted or otherwise protected values. Contextual inputs may include data inferred or generated by machine learning or artificial intelligence models trained to predict viewer preferences, behaviors, environmental context, or content relevance. This component applies business rules and potentially AI-driven decision-making processes to determine the most relevant video segments for each user. The Decisioning Core generates an Edit Decision List (EDL) that specifies the sequence and configuration of media components tailored to the individual user's profile and context.

The Streaming Core takes the EDL produced by the Decisioning Core and translates it into low-level instructions for assembling the video stream. This component is responsible for managing the intricate process of stitching together various video segments, which may include both pre-rendered content and dynamically generated elements. These may be both server side and client side. In the case of segments that are rendered on the clients the server will send instructions to the client that define how to create these. Optionally the Streaming Core first analyzes the capabilities of the clients before deciding which tasks should be performed at the client. The Streaming Core ensures that the final video stream is coherent and seamless, despite being composed of disparate elements.

The stitching process described herein preferably refers to the temporal combination of video segments, including without limitation assembling multiple clips sequentially along the timeline to create a continuous playback experience of extended duration. This temporal stitching is distinct from spatial compositing or overlay rendering, wherein multiple visual or audio layers at the same temporal position are combined to create composite frames. The system supports both temporal stitching (combining segments end-to-end) and spatial compositing (layering elements atop base video), and may employ both techniques within a single personalized video stream. For example, a program may temporally stitch together an introduction segment, a personalized main segment, and a conclusion segment, while also spatially compositing personalized text overlays atop the main segment's video content.

The system also preferably comprises the Rendering Core, which handles the real-time generation of personalized content elements. This component can utilize various rendering tools, such as FFmpeg or game engines like Unity, to create dynamic video segments on-the-fly. The Rendering Core can incorporate live data, such as weather updates, location information, or current promotional offers, to produce highly relevant and timely content for each user.

The present invention, in at least some embodiments, employs a sophisticated caching mechanism that significantly enhances the efficiency of content delivery. By caching video segments at CDN nodes, the system can reuse common elements across multiple user requests, reducing the need for redundant processing and minimizing latency. The Edge Workers, located at CDN nodes, support this process by adjusting the Presentation Time Stamps (PTS) and Decoding Time Stamps (DTS) of cached segments to ensure they fit seamlessly into each unique video stream.

According to at least some embodiments, the present invention features the ability to mix different rendering strategies within a single video stream. For example, some segments may be pre-rendered and simply require timestamp adjustments, while others might need to be generated entirely from scratch or modified with real-time overlays. This flexibility allows the system to optimize resource usage while still delivering a highly personalized experience.

The present invention also addresses the challenge of just-in-time transcoding, which is essential for ensuring frame-accurate cuts and smooth transitions between segments. This capability allows the system to adapt content on-the-fly to meet the specific requirements of each user's device and network conditions, further enhancing the viewing experience.

According to at least some embodiments, the present invention features security capabilities to maintain user privacy and to protect against unauthorized access. User requests contain data parameters, which may include encrypted or otherwise protected values, preventing unauthorized access to personal information or manipulation of the video content. Additionally, the system's distributed nature, leveraging edge computing and cloud storage, provides inherent scalability and load balancing capabilities.

According to at least some embodiments, the present invention features future extensibility options. While the description relates to adaptive streaming protocols like HLS and DASH, the architecture is flexible enough to accommodate other protocols such as, but not limited to, WebRTC; and/or RTMP, and/or progressive download formats such as progressive MP4 download, progressive MXF downloads. Such extensibility ensures that the system can evolve to meet changing industry standards and user expectations, maintaining its relevance to personalized video content delivery.

In at least some embodiments, the system implements a multi-layer rendering strategy that optimizes resource utilization through intelligent separation of rendering workloads. The system distinguishes between computationally expensive layers that are common across multiple viewers and lightweight personalized layers specific to individual users.

The system is preferably able to generate or assemble multiple layers of content, each potentially containing two-or three-dimensional graphics, generative AI, dynamic animations, or other computationally intensive components. These layers may be rendered or composed at different stages of the pipeline—on the server, client, edge, or intermediate nodes—depending on current conditions and orchestration policies.

An orchestration component evaluates contextual factors such as device capabilities, available bandwidth, energy consumption, latency budgets, and target quality or performance metrics to determine the most efficient execution strategy for each layer. This process may include choosing where a layer is rendered, whether intermediates are reused, or when to offload or precompute segments.

Layers that remain constant across multiple viewers or sessions are optionally cached at CDN nodes or persistent storage, indexed by unique identifiers and cryptographic and/or structural hashes for efficient retrieval and deduplication. The system preferably implements content-addressable storage utilizing hash-based indexing to identify, retrieve, and deduplicate intermediate video layers, wherein hash values are computed from rendering parameters, encoded content, or combinations thereof to enable efficient reuse across multiple sessions.

Each EDL section may describe multiple composable variants, ranging from reusable 3D intermediates to lightweight data-driven overlays, that can be selected or composed dynamically at runtime. Deduplication is achieved through content-addressable storage, allowing identical intermediates to share storage space regardless of where or how they were produced, preferably through content-addressable storage operating across multiple scopes. The hash-based indexing mechanism enables the system to identify identical intermediate renders regardless of whether they were generated for different users, different programs, different time periods, or different sessions of the same user. When two or more content requests produce intermediate layers with matching hash values, indicating identical rendering parameters and outputs, those requests share a single cached copy, eliminating redundant storage and computation.

The deduplication scope may span across user populations (e.g., all users in a geographic region receiving region-specific content), across temporal boundaries (e.g., the same user receiving consistent branding elements across multiple viewing sessions), or both simultaneously. This flexibility allows the system to optimize for various content organization strategies, including regional targeting, demographic segmentation, A/B testing variants, personalization tiers, and temporal campaigns.

The system may also implement anti-repetition mechanisms wherein deduplication is selectively disabled or biased to prevent showing the same intermediate variant to a user multiple times. By tracking hashes of previously-viewed intermediates per user, the system can identify and deprioritize content the user has already seen, maintaining freshness while still benefiting from deduplication across the broader user population.

The decision to create a cached intermediate versus rendering content on-demand per request may be governed by reuse prediction models, which may incorporate machine learning algorithms trained on historical usage data, content characteristics, and cost metrics. These models estimate the likelihood or frequency of reuse for a given intermediate variant and determine whether the computational cost of rendering and storage cost of caching are justified by expected future reuse. This intelligent intermediate generation strategy allows the system to evolve from simple coarse-grained caching policies toward sophisticated optimization that maximizes efficiency without over-provisioning cache storage.

Cache invalidation in the system preferably operates primarily through implicit hash-based mechanisms rather than explicit purge operations. When EDL inputs, rendering parameters, or constituent audio/video segments change, the system computes a new hash value that differs from previously cached content. Upon requesting content with the modified parameters, the hash-based lookup is designed to fail to match an existing cached intermediate, automatically triggering generation of a new intermediate without requiring explicit invalidation of the prior cached version.

The system preferably implements time-to-live (TTL) policies for cached intermediates independent of EDL or parameter changes. Cache entries may persist for extended durations (hours, days, or longer) as cached intermediates typically remain valid and reusable across many sessions. The TTL mechanism provides a storage management function, allowing eventual reclamation of disk space from intermediates that are no longer accessed, without requiring sophisticated dependency tracking or active invalidation logic.

In at least some embodiments, cache invalidation rules may be keyed on EDL inputs and rendering parameters to support explicit invalidation when source content or business rules change. However, the primary mechanism for ensuring freshness is the content-addressable architecture: because any change to inputs produces a different hash, stale content is naturally bypassed rather than requiring active purge operations. This approach simplifies cache management while ensuring that the system always generates or retrieves content matching the current request parameters.

Deduplication is preferably achieved through content-addressable storage, allowing identical intermediates to share storage space regardless of where, when, or how they were produced. Multiple different EDL configurations that happen to produce byte-identical intermediates will generate matching hash values and reference the same cached content.

The system preferably implements automatic decision logic to determine whether to generate and cache an intermediate layer or render content on-demand for each request. This decision is based on predicted reuse analysis rather than requiring manual authoring decisions for each content variant. The prediction mechanism preferably estimates how many times a particular intermediate variant will be requested, either across multiple users or across multiple sessions for the same user, and compares the expected reuse count against the costs of intermediate generation and caching.

Without wishing to be limited by a closed list, the cost-benefit analysis may considers: (i) the computational cost of rendering the intermediate (CPU/GPU time, memory usage, rendering tool licensing costs), (ii) the storage cost of caching the intermediate (disk space at origin and/or edge nodes, multiplied by cache retention duration), (iii) the network cost of distributing the intermediate to edge caches if applicable, and (iv) the aggregate rendering cost that would be incurred if the content were rendered on-demand for each request instead of cached. When predicted reuse is high, the amortized cost per view of a cached intermediate is lower than per-request rendering; when predicted reuse is low, on-demand rendering avoids wasting storage on rarely-accessed content.

In at least some embodiments, the system employs machine learning models to predict reuse likelihood. Training data comprises historical request logs annotated with intermediate characteristics (EDL parameters, rendering complexity, content attributes such as regional vs. user-specific personalization), usage patterns (request frequency, temporal distribution, user demographics), and observed cache performance (actual hit rates, retention duration before eviction). Features input to the model may include: number of users matching the personalization criteria (e.g., how many users are in the target region or demographic segment), content type and category, time-of-day and day-of-week patterns, seasonality, promotional campaign duration, and similarity to previously popular content.

The model outputs a predicted request count or reuse probability for each potential intermediate variant. The system applies a decision threshold: variants predicted to exceed the threshold are proactively rendered and cached, while variants below the threshold are rendered on-demand only if and when requested. The threshold itself may be static (configured by administrators), dynamic (adjusted based on current cache capacity and rendering queue depth), or learned (optimized to minimize total system cost based on historical performance).

In current implementations, the system may default to caching all generated intermediates, providing a conservative baseline that ensures high cache hit rates and low per-request latency. As operational data accumulates, the system transitions toward selective caching driven by reuse predictions, progressively improving resource efficiency without sacrificing user experience quality. This evolutionary approach allows the system to begin operation immediately with simple policies, while laying the groundwork for sophisticated optimization as the machine learning models train on production data.

The automatic decision logic removes the burden from content authors to manually specify caching policies for each content variant, instead allowing authors to focus on creative and business aspects of content design while the system automatically optimizes technical resource allocation. Authors may optionally provide hints or constraints (such as ‘this campaign targets 1 million users’ or ‘this content is time-sensitive and should not be cached beyond 1 hour’), which the automatic decision logic incorporates as additional factors in its predictions.

According to at least some embodiments, the system preferably implements various error handling and recovery mechanisms to ensure robust operation across diverse failure scenarios.

When a cached intermediate layer is purged from storage (due to TTL expiration, explicit invalidation, cache capacity limits, or storage system failures) but remains referenced by an active EDL, the system automatically detects the cache miss during hash-based lookup and initiates re-rendering of the required intermediate. The re-rendering process follows the same workflow as initial generation: the rendering module retrieves necessary input assets, applies the specified rendering operations according to EDL parameters, and produces a new intermediate layer that is stored in cache indexed by its hash value. This regeneration occurs transparently without requiring manual intervention or EDL modification, ensuring continuity of service even when cache state becomes inconsistent with active content requirements.

The regeneration latency depends on the complexity of the intermediate and available rendering resources. For simple intermediates (such as timestamp-adjusted static segments), regeneration may be completed within milliseconds. For complex intermediates (such as game-engine-rendered 3D scenes), regeneration may require seconds or longer. The system may implement priority queuing for regeneration requests triggered by active user sessions, ensuring that user-facing rendering receives priority over background pre-generation tasks.

In embodiments where personalized overlay layers are rendered client-side according to rendering metadata, rendering failures may occur due to insufficient client device capabilities, software bugs, incompatible browser versions, resource exhaustion, or other client-side issues. In at least some embodiments, the system does not implement automatic server-side fallback when client-side rendering fails, as such failures are expected to be rare and the complexity of maintaining parallel rendering paths may outweigh the benefit.

Instead, the system preferably relies on telemetry and error reporting mechanisms to detect patterns of client-side rendering failures. When telemetry data indicates that a particular combination of client device type, browser version, rendering operations, or content characteristics consistently produces failures, the system's decision engine adjusts future rendering location selections to avoid that problematic combination. For example, if analytics reveal that a specific overlay effect fails on a particular mobile device model, subsequent requests from that device model will be routed to server-side rendering for that effect rather than client-side rendering.

In alternative and/or additional embodiments, the system may implement automatic fallback wherein client-side rendering failures trigger a request to the server for a fully-composed server-rendered version of the affected segment. However, given the expected rarity of such failures and the additional implementation complexity, this fallback mechanism may be deprioritized in favor of proactive avoidance through telemetry-driven decision-making.

The system preferably selects hash algorithms with sufficiently low collision probability to ensure that hash collisions effectively never occur in practice. Suitable hash functions include cryptographic hashes such as SHA-256 or SHA-512, which provide collision resistance sufficient for content-addressable storage in large-scale deployments. The probability of collision with such algorithms is negligibly small (on the order of 2^-128 or lower for typical deployment scales), making collision handling unnecessary.

In the exceedingly unlikely event that a hash collision occurs, such a collision is preferably handled at the storage layer. Content-addressable storage systems typically verify content integrity by comparing stored content against newly-generated content with matching hashes, detecting the collision and resolving it through rehashing with additional salt, storing under an alternative key, or reporting an error. However, proper selection of hash algorithm may reduce or even eliminate collision as a practical concern, allowing the system to treat hash values as unique identifiers without requiring collision detection or resolution logic.

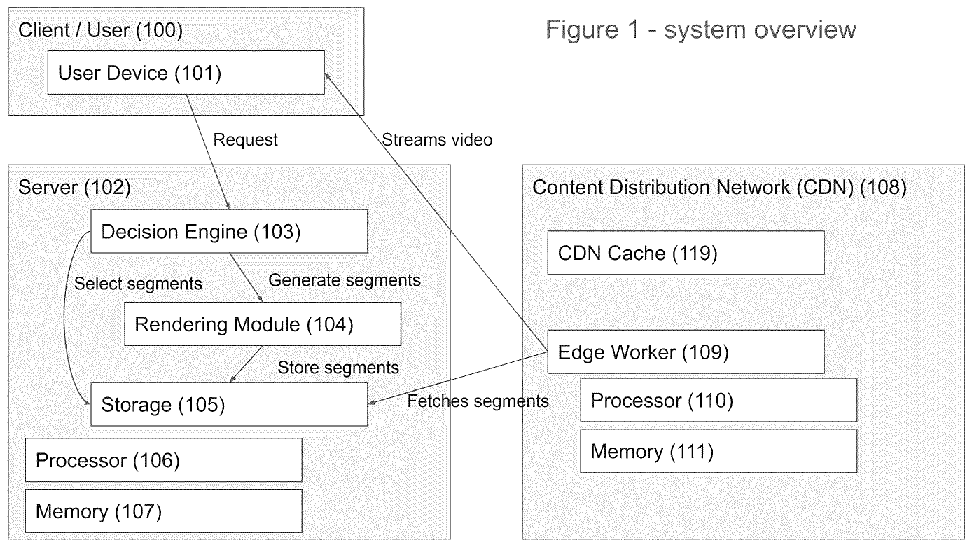

Turning now to the drawings, FIG. 1 illustrates an overview of the system architecture for real-time creation and streaming of customized videos. The system comprises a Client/User 100 side and a Server 102 side, connected through a Content Distribution Network (CDN) 108. On the Client/User side, a User Device 101 may initiate the process by sending a request for customized video content. Optionally, a non-user device triggers such a request (e.g. an automated request, or an optimization mechanism that prepares media). User device 101 may comprise any suitable user computational device that is capable of requesting and playing streaming video content, including but not limited to smart glasses or other headgear, smartphones, tablets, or computers, and the like.

Server 102 contains several key components, including a Decision Engine 103, a Rendering Module 104, and Storage 105. Decision Engine 103 may analyze data parameters from user requests and select appropriate video segments using a tag-matching system, or other appropriate system. Rendering Module 104 generates video segments in real time using tools like FFmpeg or game engines (e.g., Unity), based on dynamic data.

Server 102 also includes a Processor 106 and Memory 107 to handle computational tasks. CDN 108 facilitates efficient content delivery and includes a CDN Cache 119 and an Edge Worker 109. If present, Edge Worker 109, equipped with its own Processor 110 and Memory 111), supports fetching and processing video segments before streaming them to the User Device. Edge Worker 109 may also modify the video segments' PTS/DTS and stitch them into a seamless stream.

As noted previously, Edge Worker 109 may modify and stitch the video segments together, for example by (a combination of) adjusting Presentation Time Stamps (PTS) and Decoding Time Stamps (DTS), (trans)muxing the video segments, transcoding (parts of) the video segments, ensuring a seamless playback experience for the end-user. This method allows for segments to be cached and reused across different requests, significantly improving CDN cache efficiency. PTS/DTS acts as a clock that governs the video playback. By manipulating the clock, it is possible to ensure different pieces of video are played together without interruption. This clock is different if the segment is used in the first part of a stream vs at the end for example, as it is sensitive to the location of the segment within the stream. Normally, that would mean having to store two copies of the segment (one with the clock at the beginning and one with the clock at the end). By using Edge Worker 109, the content of the CDN response may be modified before being sent to the user device 101. The logic as described herein is then used to correct the clock so the video segments may be played in order.

As the system as described herein is able to re-use the same segment, no matter where in the video it needs to be played, CDN 108 is only required to store one copy of the segment (vs one-per-position without the system as described herein).

Server 102 may operate as an Origin Server, and may therefore process incoming requests, make decisions on video content selection, and initiate rendering of required segments.

Functions of processor 110 and/or 106 preferably relate to those performed by any suitable computational processor, which generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, such as memory 111 and/or 107 in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Also optionally, memory 111 and/or 107 is configured for storing a defined native instruction set of codes. Processor 110 and/or 106 is configured to perform a defined set of basic operations in response to receiving a corresponding basic instruction selected from the defined native instruction set of codes stored in memory 111.

In some embodiments, CDN 108 may not feature Edge worker 109, in which case the conditioning preferably occurs at server 102, acting as the origin server. Without wishing to be limited by a closed list, this implementation has some disadvantages (the video segments need to be cached after stitching instead of before, thus a larger cache is required; and so forth).

In order to be able to do frame-accurate cuts and hence to be able to assemble the video segments correctly, real-time transcoding is preferably employed. For example if the beginning of the segment does not start on a keyframe, all segments before the next keyframe are preferably (re)transcoded in real-time for immediate delivery.

To support such transcoding, optionally the system of FIG. 1 features a Transcoding Module (not shown), optionally within Rendering Module 104, and/or placed between Rendering Module 104 and Storage 105, and outputting to Storage 105. Additionally or alternatively, such a Transcoding Module may be connected to Storage 105 and Edge Worker 109, outputting to CDN Cache 119. Also additionally or alternatively, such a Transcoding Module may be connected to Storage 105. Optionally the selection of the output location from the Transcoding Module may be dynamically determined, such that frequently accessed content may be output to CDN Cache 119, while rarely-watched content may be output to Storage 105. A swapping mechanism may be used to move content between these locations according to demand. Without wishing to be limited to a closed list, such a mechanism is expected to vastly speed up the time needed to publish a new video. This example shows that just-in-time transcoding simplifies workflows for streaming tech engineers using the system as described herein, because most if not all assets are always “published”, rather than “processing”.

Optionally, the transcoding step is performed as needed. If the media are already available in the correct encoding, it won't be needed. In some cases, one or more segments may be already transcoded, while one or more other segments may not yet be transcoded (e.g. 0 -10 seconds are already transcoded, but the remainder is not). Optionally some segments are proactively transcoded.

Optionally and without wishing to be limited, the system's rendering architecture (such as that shown with Rendering Module 104) may employ a two-layer structure: a server-side intermediate layer containing shared or computationally expensive content, and a client-side personalized layer containing user-specific elements. Both layers are preferably flexible in their implementation complexity and rendering requirements. The server-side layer may comprise simple retrieval of static cached segments, timestamp adjustment of canonical segments (described in greater detail below), transcoding operations, or full rendering using game engines or video processing tools. The client-side layer may comprise minimal text overlays applied via browser APIs, complex composited graphics rendered using WebGL, HTML Canvas, or real-time effects generated by native rendering engines on the client device.

The decision of whether to generate and cache server-side intermediates or render content on-demand is made automatically based on predicted reuse, optionally employing machine learning models trained on historical usage data. This automatic decision-making relieves content authors from making technical caching determinations, allowing the system to optimize resource allocation based on actual observed patterns rather than manual predictions. In deployments where reuse prediction is not yet implemented, the system preferably defaults to caching all generated intermediates, providing a simple and reliable operational model.

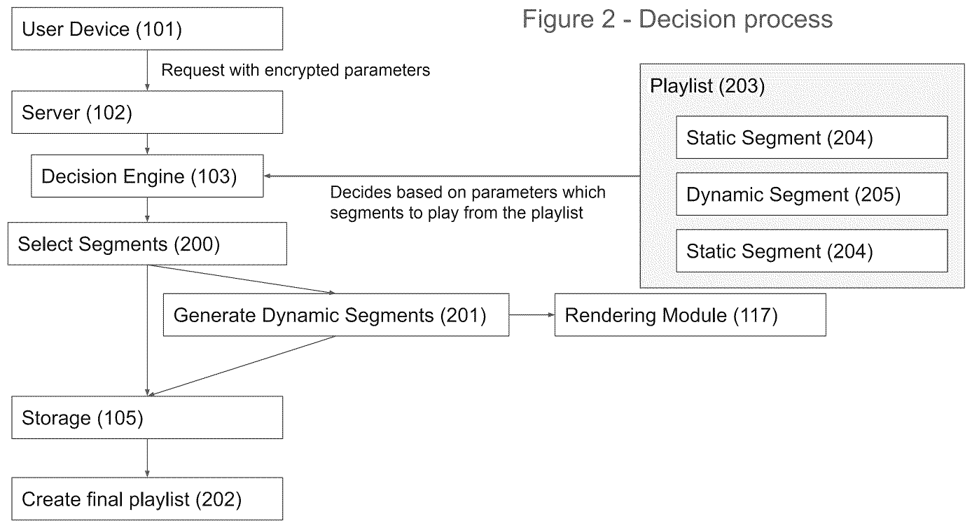

FIG. 2 depicts the workflow of processing a user request and the selection of video segments. The process begins when a User Device 101 sends a request with encrypted parameters to the Server 102. The Server passes this information to the Decision Engine 103, which determines which segments to play based on the received parameters. The Select Segments 200 step chooses appropriate segments from the Playlist 203, which preferably contains both Static Segments 204 and Dynamic Segments 205. For dynamic content, the Generate Dynamic Segments 201 step preferably creates new segments and sends them to the Rendering Module 117 for processing. Both static and dynamic segments may be stored in Storage 105. The final step, Create final playlist 202, assembles the complete, personalized playlist.

As noted above, the method preferably includes selecting content segments, applying personalization and/or localization techniques, and employing segment-specific delivery strategies to optimize content delivery and user experience. The personalized playlist may comprise multiple content segments, each associated with a specific time range and a corresponding delivery strategy. The playlist is preferably supported through modification of PTS and DTS values. The requirement to adjust Presentation Time Stamps (PTS) and Decoding Time Stamps (DTS) depends on multiple factors: whether the segment's original timestamps require modification to fit the target playlist position, whether the client device will directly access the segment, and whether the client is sensitive to timestamp discontinuities or out-of-order playback.

For segments delivered directly to end-user client devices, PTS/DTS adjustment is preferably employed to ensure seamless playback when multiple segments from different sources are combined into a single program. Each segment in a video stream must have timestamps that follow continuously from the previous segment, creating the illusion of a single coherent video file despite being assembled from disparate cached segments. The adjustment process modifies the timestamps by an offset A calculated based on the segment's position in the playlist and the ending timestamp of the preceding segment.

For intermediate layers that undergo further server-side processing before final delivery, PTS/DTS adjustment may be unnecessary. Intermediate layers stored in origin storage (rather than CDN edge caches) typically exist as rendering inputs or partially-processed content that will be further composited, transcoded, or combined with other layers before reaching the client. During these subsequent processing steps, timestamps are recalculated or normalized, making adjustment of the intermediate's timestamps superfluous.

The system preferably determines whether timestamp adjustment is required on a per-segment basis by evaluating: (i) whether the segment requires timestamp modification to fit its playlist position (comparing the segment's internal timestamps against the target position's requirements), (ii) whether the segment will be delivered directly to a client device or undergo further server-side processing, and (iii) whether the target client device is sensitive to timestamp discontinuities (some players tolerate small gaps or overlaps in timestamps, while others require strict continuity).

When these three conditions indicate adjustment is necessary as an example, the edge worker or origin server preferably performs PTS/DTS rewriting as described herein, ensuring the segment's timestamps align with playlist requirements. When conditions indicate adjustment is unnecessary, as is commonly the case for server-side intermediates that will undergo further processing, the system preferably bypasses timestamp modification, avoiding unnecessary computation and preserving the segment's original timing metadata for use in subsequent rendering stages.

Intermediate layers cached for reuse across different contexts are preferably stored with normalized internal timestamps (typically starting at or near zero), allowing the same cached intermediate to be used at multiple playlist positions through runtime adjustment of timestamps at the point of final delivery. This normalization approach maximizes cache efficiency by ensuring intermediate segments are position-independent, while deferring position-specific timestamp adjustment until the segment's playlist context is known.

For example, a playlist may include, as a non-limiting example:
1. An introduction segment (e.g., 0:00-0:05) utilizing a pre-transcoded delivery strategy with modified presentation timestamp (PTS) and decoding timestamp (DTS) values.
2. A personalized welcome segment (e.g., 0:05-0:15) employing just-in-time rendering and transcoding with modified PTS/DTS values.
3. A personalized main segment (e.g., 0:15-0:45) utilizing just-in-time modification and overlay rendering, transcoding, and PTS/DTS modification.
4. A generic main segment (e.g., 0:45-1:30) employing just-in-time transcoding with modified PTS/DTS values.
5. An ending segment (e.g., 1:30-1:45) utilizing a pre-transcoded delivery strategy with modified PTS/DTS values.

The method further comprises various content delivery strategies based on the specific requirements of each content segment. These strategies may include, but are not limited to, one or more of:
a. Streaming pre-transcoded content without modification;
b. Streaming pre-transcoded content with modified PTS/DTS values;
c. Rendering content segments from scratch in real-time;
d. Modifying original content segments by rendering overlays;
e. Modifying original content segments by rendering overlays on the client device, orchestrated by frame-accurate metadata sent from the server;
f. Modifying original content segments through complete transformation;
g. Modifying original content segments through complete transformation and/or rendering from scratch on the client device, orchestrated by frame-accurate metadata sent from the server.

Optionally, these various methods may be combined with the above personalized playlist, to provide a hybrid delivery method that uses different processes (paths) to deliver the video and/or segments. As a non-limiting example (the numbers indicate the location in the video or audio by seconds elapsed from the start):

### Video:

0:00-0:02 is existing segment
0:02-0:06 is rendered by Unreal Engine but not personalized
0:06-0:15 is rendered by Unreal Engine and personalized
0:15-0:30 is existing content with personalized texts/overlays

### Audio:

0:00-0:30 has stock music+personalized voice-over

As part of this hybrid approach, part of the video may be rendered by the server (for example as an intermediary render) and part by the client. In the example above for video, within the video, seconds 0:15-0:30 may be done client-side, while seconds 0:06-0:15 are personalized server-side, and the rest of the video is pre-existing.

Optionally, the system may render an intermediary server-side, and then do the next step server-side as well, for example the client doesn't support text/image overlaying. Some of the paths described herein may be real-time, others may require asynchronous processing (i.e. retrieving content at a third-party API may not occur in real time, while overlaying graphics may).

These additional features are preferably provided by an orchestration engine, which may optionally be located at the decision engine 103 as described above, or alternatively may be separate. The orchestration engine preferably makes its choices depending on device capabilities, speed/capacity constraints, and efficiency. Optionally and preferably, such orchestration is further supported through a corrective CDN-Edge layer where certain properties like PTS/DTS may be changed. The content is also optionally re-muxed, or re-muxed into a different stream type (e.g. MPEG-DASH instead of HLS), with or without the addition or modification of DRM encryption, optionally including replacement or re-encryption of content encryption keys, license identifiers, or initialization vectors, while preserving the underlying media payload. Certain canonical segments or associated assets may be re-encrypted or re-wrapped with per-session or per-viewer keys during transmission, ensuring that derivative or reused segments remain compliant with digital rights management and content licensing requirements. These additional features may also support tracking of content consumption, including statistics of specific elements AND/OR scenes/clips and how often they are viewed.

The system implements a per-segment orchestration framework that selects delivery strategies to optimize an objective function. For each segment of a requested program, decision engine 103 evaluates multiple candidate strategies which may include: (a) pre-transcoded delivery with timestamp adjustment only, (b) just-in-time transcoding, (c) server-side rendering from templates or game engines, (d) client-side overlay rendering governed by metadata, (e) generative AI inference, and (f) hybrid combinations thereof.

The selection process preferably operates subject to constraints including latency budgets (e.g., segments must be ready before the playback buffer depletes) and quality thresholds (minimum resolution, bitrate). The objective function minimizes a weighted combination of accumulated latency, compute cost (server CPU/GPU cycles), and energy consumption (both server-side and client-side).

The system preferably persists selection outcomes and observed playback metrics to a telemetry database (not shown). Metrics collected preferably include actual render times, transcode durations, network delivery latency, client-side rendering performance, and playback quality indicators (rebuffering events, dropped frames). Subsequent strategy selections incorporate this historical data as feedback, biasing toward strategies that have performed well for similar device profiles and network conditions.

Scene-level and element-level consumption tracking records which specific segments, overlays, or dynamic elements were viewed, enabling content popularity analysis and informed cache preloading decisions.

In at least some embodiments, the telemetry subsystem collects both technical and behavioral metrics, including network performance, render duration, engagement rate, and conversion data. The orchestration engine continuously refines decision policies using these metrics to optimize multiple objectives, such as playback quality, latency, compute cost, and business outcomes (for example, maximizing viewer engagement, click-through, or conversion rate). Over successive sessions the system self-adjusts, producing a closed feedback loop that aligns delivery and content-selection strategies with both technical efficiency and business performance goals.

It is also possible to create a templateless dynamic video by specifying the EDL (Edit Decision List, or “cut”) of the video. This is technically identical to being able to play back a video from a video editor file (e.g. .ppro Premiere Pro project file+its project assets), without the need to export this video first.

When intermediate video layers and personalized overlay layers are rendered separately, potentially at different times, by different processing components, or at different locations (server-side vs. client-side), the system preferably maintains frame-accurate synchronization through normalized timing metadata and explicit timecode specifications.

The system preferably treats each segment's internal timestamps as normalized to a zero baseline, disregarding the absolute PTS/DTS values embedded in the segment encoding and instead relying on the segment's position within the EDL and its known duration to determine temporal alignment. This approach decouples the rendering of individual layers from their final temporal positioning in the assembled program, allowing layers to be rendered independently without coordination of their internal timing metadata.

When compositing layers, the system aligns them based on their EDL-specified start times and durations rather than their encoded PTS/DTS values. For example, if the EDL specifies that an overlay should appear from 0:05 to 0:15 in the program timeline, and the underlying base video segment spans 0:00 to 0:30, the compositing operation aligns the overlay with the correct frames of the base video by calculating frame positions based on frame number, frame rate and timecode rather than by matching PTS values.

The rendering metadata stream provides frame-accurate timecode specifications for overlay elements, indicating precisely which frames of the base video should receive which overlay elements. Timecodes are specified with millisecond-level granularity, allowing precise synchronization even in high-frame-rate content. For a 30 fps video, millisecond-level timecode precision provides sub-frame accuracy (approximately 0.03 frames), ensuring overlays align correctly with intended video frames.

Overlays are typically added on a per-segment basis, with the rendering metadata stream specifying overlay parameters for each segment independently. This segmented approach limits the scope of timing coordination: synchronization must be maintained within each segment, while continuity across segment boundaries is preserved through timestamp adjustment and runtime interpolation when overlays are intended to persist. Within a segment, frame rate consistency ensures accurate overlay positioning—as long as the base video and overlay rendering both operate at the specified frame rate, frame-level alignment is maintained through timecode calculations.

In cases where frame rate variability occurs (due to variable frame rate source content or rendering inconsistencies), some temporal misalignment may occur between base video and overlays. However, customers can compensate for such variability through the system's support for highly granular timecode specifications, adjusting overlay timing with millisecond precision to achieve correct alignment despite frame rate irregularities.

When transitioning between EDL sections that specify different intermediate layers, the system ensures seamless playback through coordinated timestamp adjustment and segment boundary alignment. Each EDL section specifies a time range and the associated intermediate layers for that range. At section boundaries, the system selects appropriate segments from the respective intermediate layers and applies timestamp adjustment to create continuity.

For example, if EDL Section A (covering program time 0:00-0:30) uses Intermediate Layer X, and EDL Section B (covering 0:30-1:00) uses Intermediate Layer Y, the transition at the 0:30 mark is handled by: (i) selecting the final segment from Layer X with appropriate ending timestamp, (ii) selecting the initial segment from Layer Y, (iii) adjusting Layer Y's segment timestamps so that its starting PTS follows immediately after Layer X's ending PTS, and (iv) delivering both segments in sequence to create uninterrupted playback.

When segment boundaries do not naturally align with keyframes, the system performs selective transcoding of frames immediately surrounding the transition point to ensure proper decoding dependencies are maintained, as described elsewhere herein. Optionally, to ensure that segment boundaries align on keyframe positions when possible, boundary alignment may be performed at transcode time (earlier in the workflow) or during a just-in-time transcode by the origin server.

This transition handling mechanism is preferably implemented to operate transparently regardless of whether intermediate layers differ in their rendering source, personalization parameters, or technical characteristics, allowing the EDL to freely specify arbitrary combinations of intermediate layers across the program timeline while the system automatically manages the technical complexities of seamless assembly.

When using multiple rendering steps to create a dynamic video output, it is possible for the system to create an intermediate video which contains some but not all of the output layers. For instance an intermediate video may contain 3D rendered segments, but may not yet contain 2D rendered text.

By using a multi-layer approach, it is possible to separate the creation of these layers, for example because it may be possible to use a 3D rendered server-side output for multiple viewers, deduplicating its generation by intermediate storage or caching. If the 2D rendered text contains more personalized information, this much lighter and cheaper process may be executed separately on the client, saving resources.

Such separation also supports hybrid server-side/client-side rendering. The rendering engine can ultimately make that decision based on known device characteristics that may be passively and actively queried on the device prior to rendering. In cases of client-side or hybrid rendering, the rendering engine preferably creates a metadata stream that is interpreted by the client in order to commence the rendering process. In addition to the metadata stream, additional assets may be provided (by means of manifest, or by means of adding them to the metadata stream), so that the device may render such assets.

In some embodiments the program may comprise (i) a server-rendered intermediate that contains expensive or three-dimensional layers common to many viewers, and/or layers created using generative AI (inference), and (ii) a personalized layer rendered separately (e.g., as two-dimensional overlays). For example, a “main” EDL section may have five non-personalized 3D variants rendered server-side as intermediates, while a personalized overlay layer may have one thousand textual or graphical variants rendered client-side according to rendering metadata. Preferably, the identifier comprises a hash as described herein.

Intermediates may be cached and reused across sessions, with cache entries persisting according to configurable time-to-live (TTL) policies. The system stores identifiers, preferably comprising hash values as described herein, for each cached intermediate. These hashes enable both deduplication (ensuring identical content shares storage) and implicit cache invalidation through hash-based lookup mechanisms.

The number of intermediate variants generated and cached for any given content segment is preferably determined by a combination of factors including available storage capacity, computational resource limits, EDL complexity, predicted usage patterns, and cost optimization objectives. The system balances these constraints to determine an optimal variant count that maximizes personalization benefits while remaining within operational resource budgets.

In at least some embodiments, the system optionally implements a two-layer architecture comprising one server-side intermediate layer and one client-side personalized layer, providing a practical balance between caching efficiency and personalization granularity. The server-side layer contains computationally expensive elements common across multiple viewers (such as three-dimensional renders, generative AI, complex animations, or high-quality video processing), while the client-side layer applies lightweight personalized elements (such as text overlays, user-specific graphics, or localized content). Both layers remain flexible in their implementation, allowing the server-side layer to vary in complexity from simple timestamp-adjusted static segments to fully-rendered dynamic content, and the client-side layer to range from minimal text overlays to sophisticated composited effects.

The system may expand beyond two layers when justified by content requirements and resource availability. For complex programs, multiple server-side intermediate layers may be generated at different levels of personalization granularity (for example: a base layer common to all users, a regional layer with variants for each geographic market, and a demographic layer with variants for age groups or user segments), with final personalization applied client-side. The determination of how many layers and how many variants per layer to generate may be made manually during content authoring, automatically based on analysis of EDL structure and predicted reuse patterns, or through hybrid approaches combining author guidance with system optimization.

In embodiments employing machine learning for variant management, predictive models preferably analyze factors including: storage costs (per-variant storage multiplied by expected variant count), computational costs (rendering time and resource consumption per variant), predicted request distribution across variants (how many users will request each specific variant), cache infrastructure capacity (available storage at origin and edge nodes), and content lifecycle (limited-time campaigns may justify fewer cached variants than evergreen content). The model outputs a recommended variant count and layer structure that optimizes a cost-benefit objective function, potentially subject to constraints such as maximum storage budget or minimum personalization quality thresholds.

As the system accumulates operational data, machine learning models may identify patterns such as ‘demographic variants achieve 80% cache hit rates while user-specific variants achieve only 20% hit rates,’ leading to automatic optimization decisions such as increasing the granularity of demographic variants (creating more variants to improve personalization) while reducing user-specific intermediate caching in favor of client-side rendering. This adaptive approach allows the system to continuously improve resource efficiency and personalization effectiveness based on real-world usage.

Cache invalidation preferably operates primarily through lazy evaluation: when any EDL input, rendering parameter, or constituent audio/video segment changes, the computed hash differs from existing cache entries. The system then detects no matching cached intermediate during hash-based lookup and proceeds to generate fresh content. Previous cached versions may remain in storage until TTL expiration or explicit storage reclamation occurs, but are preferably effectively invalidated by virtue of no longer matching current request hashes.

The identifier, which preferably comprises a hash computed as described herein, serves as the primary key for content-addressable retrieval. By using hash-based indexing rather than explicit dependency tracking, the system avoids the computational overhead and complexity of maintaining invalidation graphs or monitoring source content changes. Any modification to inputs automatically produces a cache miss, triggering regeneration only when necessary while allowing unchanged intermediates to be efficiently reused across arbitrarily many sessions. In certain embodiments, prior to rendering or segment assembly the system performs capability negotiation, which may include one or more of: querying codec profiles and hardware acceleration, GPU presence and shader model, memory and CPU cores, display resolution and refresh rate, and network throughput and volatility. The orchestration engine selects, per segment and per layer, whether to render server-side, client-side, or both, subject to a latency budget and a compute and energy objective function. The decision, and any fallback policy, may be communicated within a rendering-metadata stream as defined herein. A scheduler may select an instance type for server-side rendering consistent with requested compute capabilities (e.g., CPU-only, GPU-enabled) indicated by the rendering-metadata. The orchestration engine can persist observed metrics (startup time, rebuffer ratio, dropped frames, scene-level interaction) for subsequent sessions and use them to bias future decisions.

The server as described herein, alone or with a CDN featuring an edge worker, preferably dynamically selects and applies these strategies throughout the duration of the content, based on personalization requirements for each viewer. This approach combines elements of existing content delivery technologies in a novel manner, governed by a unique decision-making framework that determines the appropriate strategy for each content segment.

FIGS. 1 and 2 together therefore provide a flexible and efficient approach to delivering highly personalized digital content, optimizing both server-side and client-side resources while maintaining a high-quality user experience.

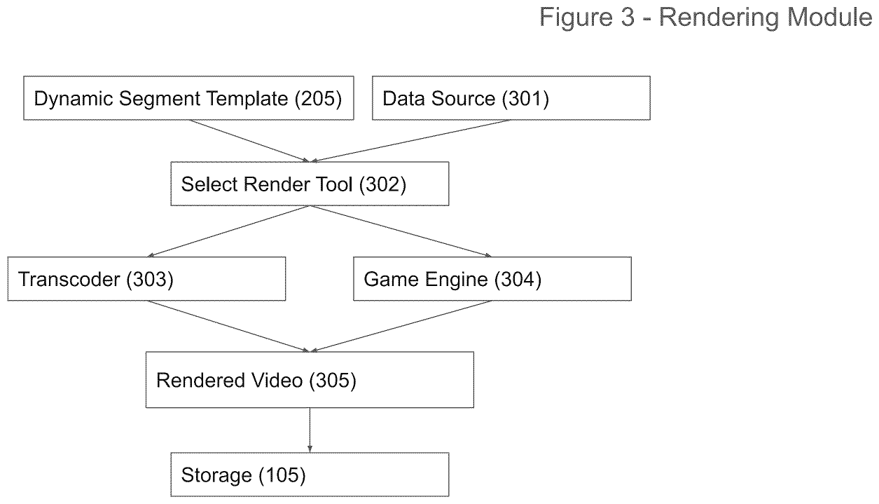

FIG. 3 shows the process of real-time generation of video segments using rendering tools within the Rendering Module. The process begins with two inputs: a Dynamic Segment Template 205 and a Data Source 301. These inputs feed into a Select Render Tool 302 component, which determines the appropriate rendering method. The rendering can be performed by either a Transcoder 303 or a Game Engine 304, depending on the requirements of the dynamic segment. Another suitable rendering tool may be provided in addition to, or in place of, one or more of these tools. Both rendering paths converge to produce Rendered Video 305, which is then stored in Storage 105 for further use in the video streaming process.

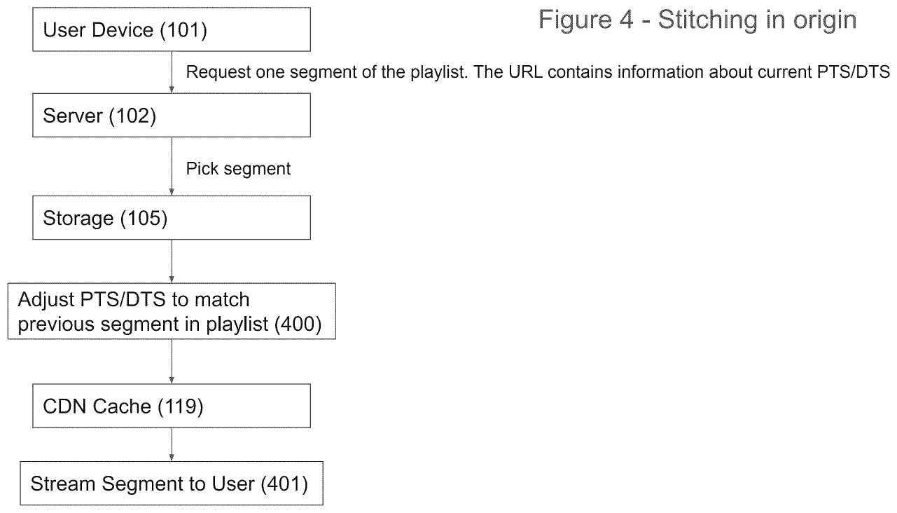

FIG. 4 outlines the stitching and streaming process via workers, specifically focusing on the origin server's role. The sequence begins with the User Device 101 sending a request for one segment of the playlist to the Server 102. This request contains information about the current Presentation Time Stamp (PTS) and Decoding Time Stamp (DTS) in the URL. The Server 102 retrieves the appropriate segment from Storage 105 and preferably performs an adjustment process 400 where the segment's PTS/DTS is modified to match the previous segment in the playlist. Adjustment process 400 supports the correct handling of the segment. This adjusted segment is then stored in the CDN Cache 119 before being streamed to the User computational device 401 for playback. Importantly, the CDN caches these altered segments, allowing them to be reused for future requests, thereby optimizing performance and reducing processing overhead.

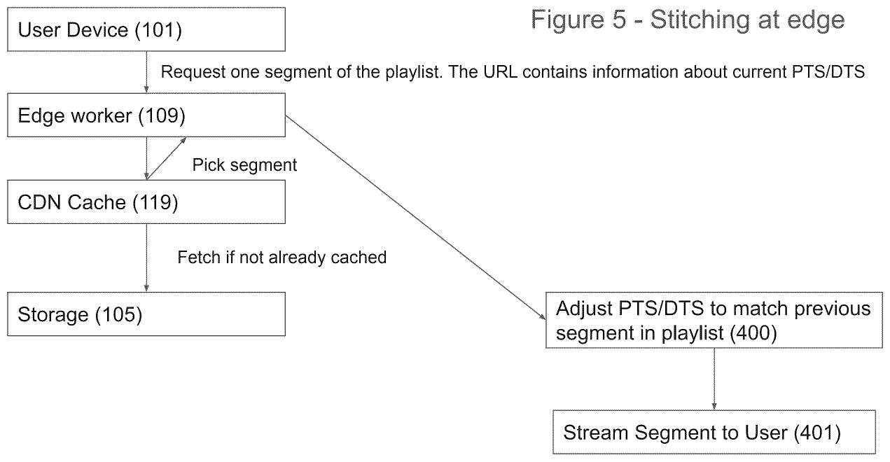

FIG. 5 demonstrates the caching mechanism and reuse of video segments across multiple requests, focusing on the CDN. The diagram shows the flow of a request for a single segment of a playlist from a User Device 101 to a previously described Edge Worker 109. Edge Worker 109 retrieves a segment from CDN Cache 119, which fetches the segment from Storage 105 if it's not already cached. Preferably CDN Cache 119 only caches unaltered segments, allowing them to be used for any request regardless of position in the playlist. Edge Worker 109 then adjusts the PTS and DTS to match the previous segment in the playlist 400, ensuring seamless playback when segments are stitched together. Finally, the adjusted segment is streamed to the User device 401. This approach allows for efficient reuse of cached segments in different playlist positions by simply adjusting their timestamps at the edge.

Consider a canonical segment S with PTS starting at 2.000 s and key frames at 0.000 s and 2.000 s in the segment's local clock, and a playlist position k where the previous emitted segment ended at PTS 10.300 s. The edge computes Δ=10.300−2.000=8.300 s and adds Δ to all PTS/DTS in S. If the requested splice point within S falls at 2.300 s (0.300 s after a key frame), the edge remuxer emits access units with PTS'=PTS+8.300 s and DTS'=DTS+8.300 s. When the splice point precedes the first key frame of S, the edge performs a short GOP-head transcode up to the next key frame while keeping the remainder remuxed only. This enables reuse of a single cached rendition of S at multiple playlist positions without pre-rendering position-specific copies. A canonical segment as described herein may feature multiple media content chunks. For example, a content chunk may last 2 seconds, such that a canonical segment of 16 seconds would feature 8 such chunks. A personalization strategy may be chosen per chunk. For example, in a canonical segment, it is possible that only the last 2 seconds are personalized. In this example, only the chunks that cover those last 1 or 2 segments would need to be processed separately, while the remainder could be used without processing. This makes the system easy to use and flexible for the end-user, while still being efficient when it comes to resource usage.

It should be noted that a “content chunk” as described herein may correspond to a segment as defined in the HTTP Live Streaming (HLS) protocol, developed by Apple, or similar protocols.

A canonical media segment, as used herein, refers to a media segment encoded with position-independent timing metadata. Such a segment is preferably a self-contained version of content, which is also preferably not cut down further into smaller pieces. The segment may be considered as a base or template version of content, over which additional templating and/or personalization may be added. Canonical segments are preferably stored with internal presentation timestamps (PTS) and decoding timestamps (DTS) that begin at a reference point (such as zero) rather than reflecting the segment's absolute position within a complete program. This position-independence allows the same canonical segment to be reused across multiple playlist positions and different programs by applying runtime timestamp offsets at the point of delivery, without requiring re-encoding of the segment content itself. Canonical segments are typically cached at CDN nodes, such as from CDN cache 119 as described above, and retrieved on-demand, with edge workers 109 performing timestamp adjustment operations to adapt each segment to its target position in the requested video stream. A canonical segment preferably starts with both audio and video keyframes.

The system optionally and preferably supports adaptive bitrate (ABR) streaming, a technique for delivering video content at multiple quality levels to accommodate varying network conditions and device capabilities. An ABR ladder (also referred to as an encoding ladder, bitrate ladder, or quality ladder) comprises multiple encoded renditions of the same video content, each rendition having different resolution, bitrate, and quality parameters.

A canonical segment is preferably encoded in a master format before ABR ladder generation, such that a master format (or mezzanine format) is created, and from that an ABR ladder.

An exemplary ABR ladder might include renditions such as:
1920×1080 resolution at 6 Mbps (high quality, for fast connections and large screens)
1280×720 resolution at 3 Mbps (medium-high quality)
854×480 resolution at 1.5 Mbps (medium quality)
640×360 resolution at 800 Kbps (low quality, for slower connections)
426×240 resolution at 400 Kbps (minimum quality, for severely constrained networks)

Each rendition in the ladder is preferably encoded independently, typically using the same codec (such as H.264, H.265/HEVC, or AV1) but with different encoder parameters to achieve the target bitrate and resolution. The renditions are segmented identically, meaning that each segment duration (typically 2-10 seconds) is consistent across all quality levels, and segment boundaries align on the same temporal positions and preferably on keyframe boundaries.

During playback, the client device's media player preferably monitors available network bandwidth, buffer status, and playback conditions, and dynamically switches between renditions to optimize quality-of-experience. When bandwidth is abundant, the player selects high-bitrate renditions for maximum quality. When bandwidth decreases or buffer depletion threatens, the player switches to lower-bitrate renditions to maintain continuous playback without rebuffering. This switching occurs at segment boundaries, allowing seamless transitions between quality levels.

According to at least some embodiments, the system preferably generates ABR ladders for both static segments and dynamically-rendered segments. For static segments stored in the repository, ABR ladders may be pre-generated during content ingestion and stored in multiple renditions. For dynamically-rendered segments, the rendering module or transcoding module generates multiple renditions on-demand or just-in-time, creating a complete ABR ladder for each unique dynamic segment.

The precise alignment of segment boundaries across all renditions in the ladder supports ABR streaming functionality. Segment boundary alignment ensures that segments representing the same temporal range in different quality renditions can be freely interchanged during playback without causing timing discontinuities or decoding errors.

For example, if Segment 5 in the 1080p rendition covers program time 0:20.0 to 0:26.0, then Segment 5 in the 720p, 480p, and all other renditions must also cover exactly 0:20.0 to 0:26.0. This alignment is achieved through careful encoder configuration ensuring that keyframes (I-frames) occur at identical temporal positions across all renditions, and that segment boundaries are placed at these keyframe positions.

Maintaining segment boundary alignment supports the timestamp adjustment mechanisms described herein. When the edge worker or origin server adjusts PTS/DTS values of a cached segment to fit a particular playlist position, the adjusted timestamps must remain valid across all renditions of that segment. If segment boundaries were misaligned, a client switching from one rendition to another mid-segment could experience timestamp discontinuities, decoder errors, or visual artifacts.

The system's content-addressable caching preferably operates at the segment level, storing each segment in its canonical form (with normalized timestamps) for each rendition in the ABR ladder. When a request specifies a particular quality level (bitrate/resolution), the edge worker retrieves the appropriate rendition from cache, applies timestamp adjustment, and delivers it to the client. Because segment boundaries align across renditions, the timestamp adjustment offset A remains consistent regardless of which rendition is selected, simplifying the adjustment logic and ensuring seamless ABR switching.

For dynamically-rendered segments, the system may generate ABR ladders through one of several exemplary approaches:
(i) Multi-rendition rendering: The rendering module (game engine, transcoder, or other tool) directly outputs multiple resolution/bitrate variants during the rendering process. Optionally only one or a limited number of such variants are created. For example, a game engine rendering at native 4K resolution may simultaneously output downscaled 1080p and 720p versions, or may alternatively only output one such version, or may alternatively not output a high-quality master.
(ii) Single-rendition rendering with transcoding: The rendering module produces a single high-quality master rendition, which is then transcoded by the transcoding module into multiple lower-quality renditions comprising the ABR ladder.
(iii) On-demand transcoding: The rendering module produces a master rendition that is cached. When a client requests a specific quality level, the transcoding module generates that rendition on-demand if not already cached. Subsequent requests for the same quality level retrieve the cached transcoded rendition.

The selection among these approaches depends on factors including rendering module capabilities, transcoding latency requirements, cache storage capacity, and expected distribution of client quality requests. High-demand content may justify pre-generation of complete ABR ladders to minimize latency, while rarely-accessed content may use on-demand transcoding to conserve storage.

In at least some embodiments, a single cached canonical segment serves multiple quality levels through runtime transcoding or quality selection. However, more commonly, the system caches one canonical segment per quality rendition, with each canonical segment being position-independent (normalized timestamps) but quality-specific. Optionally, the edge worker retrieves the canonical segment matching the requested quality level, applies position-specific timestamp adjustment, and delivers the result. Alternatively, an origin server retrieves the canonical segment, distributes it as a segment and/or a plurality of chunks to an edge server, where edge workers preferably then change the timestamps. In this latter optional implementation, the edge worker does not work with canonical segments directly. In some embodiments, the origin server dynamically packages canonical segments or newly rendered intermediates into segments suitable for adaptive streaming protocols such as HTTP Live Streaming (HLS) or Dynamic Adaptive Streaming over HTTP (DASH). During this packaging process, the system may optionally perform partial or full transcoding or compositing to incorporate additional intermediate or overlay layers prior to distribution. These dynamically packaged segments, while derived from canonical sources, may be regarded as non-canonical or transient segments produced for immediate delivery rather than persistent reuse. This approach allows the system to reuse cached segments efficiently: for a given content segment appearing at multiple positions in various playlists, the system stores N cached renditions (where N is the number of quality levels in the ABR ladder), rather than N×M cached renditions (where M is the number of distinct playlist positions). The timestamp adjustment mechanism handles position variance, while the quality-specific caching handles ABR support, achieving significant storage efficiency compared to caching fully-position-and-quality-specific variants.

A canonical segment may itself encapsulate one or more intermediate layers that are reused across multiple programs.

Optionally, edge worker 109 performs timestamp rewriting operations without full decode-and-reencode of the media segment. When a canonical segment is retrieved from CDN cache 119, edge worker 109 preferably calculates a presentation-time offset Δ based on the target playlist position k and the presentation time of the previously emitted segment. The system applies this offset to modify PTS and DTS values in the segment's metadata structures.

In cases where the requested start point would result in access units preceding a key frame (I-frame), the system preferably performs selective transcoding of only those frames up to the next key frame, rather than reprocessing the entire segment. This approach minimizes computational overhead while ensuring proper decoding dependencies are maintained. The canonical segment stored in cache is position-independent, allowing a single cached rendition to serve multiple playlist positions and bitrate variants through runtime timestamp adjustment.

The system's caching architecture preferably prioritizes efficient reuse of computationally expensive intermediates while ensuring content freshness through implicit invalidation mechanisms. Rather than implementing complex active invalidation systems that track dependencies and propagate updates, the system leverages its hash-based content addressing to achieve automatic cache invalidation as a natural consequence of parameter changes.

When a request requires an intermediate layer, the system computes a hash based on all inputs that affect the intermediate's content, including: EDL section definitions, rendering parameters (resolution, codec settings, effects parameters), references to constituent static video or audio segments, data source values (such as weather information or promotional content), and any other variables that influence the rendering output. This hash serves as a cache lookup key. Audio and video components may also be hashed individually to facilitate cases where only one modality, either the audio or the video, is personalized.

If inputs remain unchanged between requests, even across different user sessions, different programs, or different time periods, the computed hash preferably matches a cached intermediate, enabling immediate reuse without re-rendering. Conversely, if any input changes (an EDL is modified, a referenced segment is updated, a data source returns different values, or rendering parameters are adjusted), the new hash will not match existing cache entries. The system interprets this cache miss as an implicit invalidation signal and proceeds to render a fresh intermediate, which is then cached under the new hash value.

The prior cached intermediate is not immediately purged or deleted. Instead, it remains in storage subject to time-to-live (TTL) policies configured for cache management. TTL values may be set based on storage capacity constraints, content update frequency expectations, or operational policies. Extended TTL periods (hours, days, weeks, or longer) are practical because the hash-based lookup ensures that stale content will not be served. Even if it remains physically present in cache, it will not match current request hashes and therefore will not be retrieved.

Without wishing to be limited by a closed list, this lazy invalidation approach provides several advantages: (1) it eliminates the need for complex dependency tracking across EDL inputs, rendering parameters, and source segments; (2) it avoids race conditions or consistency issues that can arise with active invalidation in distributed caching systems; (3) it naturally supports experimentation and A/B testing, as different parameter sets coexist in cache without conflict; and (4) it simplifies cache management logic, as the only required operations are hash computation, lookup, storage, and eventual TTL-based expiration.

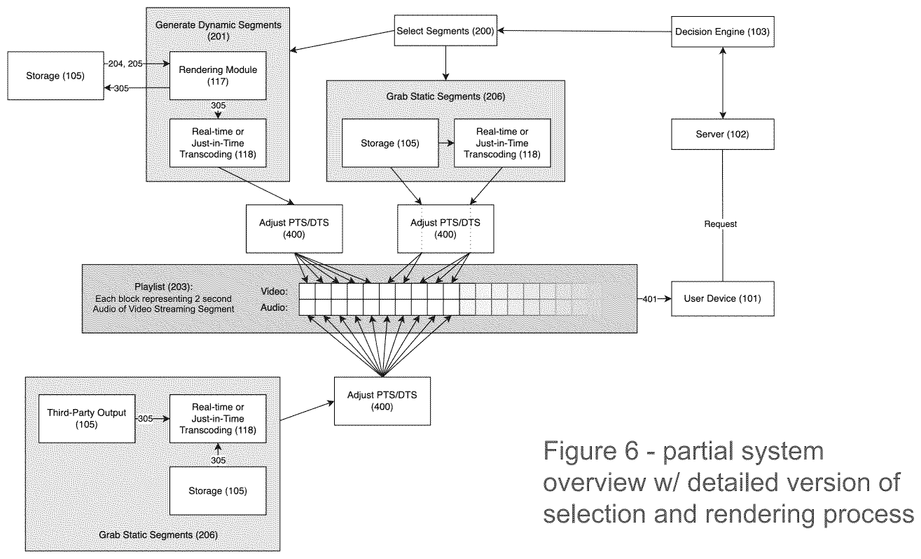

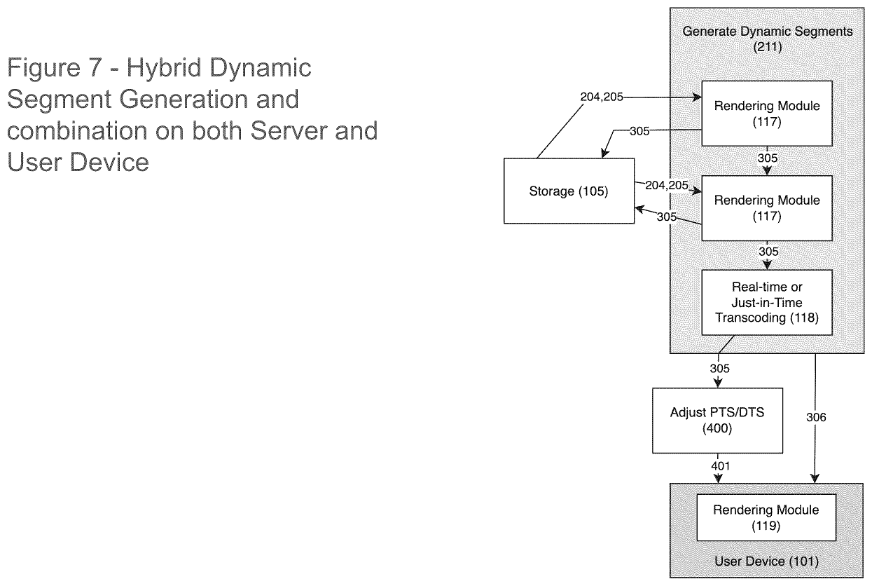

In some embodiments, explicit cache invalidation rules keyed on EDL inputs may supplement the implicit hash-based mechanism. For example, when a content author publishes a global update to a template or asset library, the system may proactively compute affected hash values and mark corresponding cache entries for purge or regeneration. However, even in the absence of such explicit invalidation, the hash-based architecture ensures correctness: updated content will generate new hashes and trigger fresh rendering automatically. The PTS/DTS adjustment process illustrated and described above preferably applies to segments delivered directly to client devices for playback. Intermediate layers undergoing further server-side processing (such as additional compositing, transcoding, or layer combination) typically do not require timestamp adjustment at the intermediate storage stage, as timestamps will be recalculated during subsequent processing. The decision to perform timestamp adjustment depends on whether the segment is final delivery content or an intermediate input to further rendering operations.
FIG. 6 shows a partial system overview containing a more detailed version of the decision process (also featured in FIG. 2), combined with a scenario where stitching is applied and selection and rendering of video and audio segments is performed in intermediary components. As indicated on FIGS. 4 and 5, parts of the process may be run on various parts of infrastructure, such as on origin and on edge. Additionally, it shows how different segments of videos may be streamed as part of a playlist.
The process begins when a User Device 101 sends a request with encrypted parameters to the Server 102. The Server passes this information to the Decision Engine 103, which determines which segments to play based on the received parameters.
It is possible to mix Static Segments and Dynamic Segments, which means the result is always a Dynamic Segment. Audio and video may follow separate paths, where both may be static, dynamic, or one may be dynamic and the other may be static.
Generate Dynamic Segments 201 employs a Rendering Module 117 which could have multiple implementations i.e. Unreal Engine. This Rendering Module 117 can pull from Static Segments 204 in Storage 105, and change them. It can also retrieve assets needed to perform the rendering i.e. textures, imagery, and more, unlimited 205. Real-time or just-in-time transcoding is an optional part of the process 118. The output is preferably encoded in a way that is consumable by User Devices 101. In some cases the Rendering Module 117 may already create an output that does not require additional transcoding anymore. Both for audio and video this step may include a compositing video or mixing audio step, where multiple renditions are combined into a more final version of the segment.
Rendering Module 117 is preferably capable of both temporal stitching operations and spatial compositing operations. Temporal stitching combines video segments sequentially to create longer programs, as described in connection with PTS/DTS adjustment mechanisms. Spatial compositing combines multiple visual or audio layers at overlapping time ranges, rendering overlays atop base video content or mixing multiple audio tracks.
For spatial compositing, Rendering Module 117 may apply programmable overlay operations including alpha blending, chroma keying, text rendering with specified fonts and positioning, image overlay with transformation matrices (scaling, rotation, translation), animated graphics synchronized to video timecode, and multi-track audio mixing. These compositing operations may be defined through the EDL, specified in the rendering metadata stream 306, or determined programmatically based on user profile data and dynamic inputs.
The Rendering Module 117 may execute compositing operations using various underlying technologies including video processing libraries (FFmpeg, GStreamer), game engines with compositing capabilities (Unity, Unreal Engine), dedicated compositing software, generative AI (inference) infrastructure, or custom rendering pipelines optimized for specific overlay types. The selection of compositing technology depends on the complexity of required operations, performance requirements, and whether rendering occurs server-side or client-side.
The rendering metadata stream 306 preferably specifies overlay timing using absolute timecodes referenced to the segment's normalized timeline rather than relying on PTS/DTS values from the encoded video stream. This approach allows overlay timing to remain consistent regardless of whether the underlying video segment has undergone timestamp adjustment. For example, an overlay specified to appear at timecode 00:00:05.250 (5.25 seconds into the segment) will be rendered at the corresponding frame position based on frame rate calculation, independent of what PTS value that frame carries in the encoded bitstream.
Timecode specifications support millisecond granularity (e.g., HH:MM:SS.mmm format) or finer, providing sub-frame precision for overlay positioning. The client-side rendering module converts timecodes to frame numbers using the segment's frame rate (frame_number=timecode_in_seconds×frame_rate), ensuring that overlays appear on the intended frames even in the presence of frame rate variations or timestamp adjustments applied to the underlying video.
Grab Static Segments 206 shows how segments may already be available for streaming to the viewer except for the final PTS/DTS adjustment step and they can be grabbed directly from the Storage 105. Other segments may still require to be transcoded just-in-time 118.
After creation these segments are preferably immediately streamed to the User Device 101 through streaming process 401, either directly or via a CDN Cache 119, where PTS/DTS adjustment may be done 400.
In FIG. 6, the Playlist 203 has been visualized spatiotemporally to indicate how different segments of videos may be streamed as part of the overall content delivery process.
The system optionally maintains a hash table or similar data structure mapping hash values to storage locations of intermediate renders. Before initiating rendering of a new intermediate layer, the Rendering Module 117 preferably computes a hash based on the input parameters and queries this index. Upon finding a matching hash, the system retrieves the existing intermediate from Storage 105 or CDN Cache 119, avoiding redundant computational expense. The hash-based lookup mechanism preferably operates independently of the specific hash algorithm employed, providing implementation flexibility while ensuring content deduplication and efficient cache utilization.
FIG. 7 shows an alternative embodiment where layer compositing may occur at multiple pipeline stages. Server-side Rendering Module 117 may generate intermediate video layers and perform initial compositing operations (such as combining multiple 3D-rendered elements or mixing background audio tracks). These intermediate renders are transmitted to User Device 101 alongside Rendering Engine Metadata 306.
Client-side Rendering Module 119 receives both the intermediate video segments and the metadata instructions, and performs additional compositing operations to add personalized overlay layers. For example, the server-side module may render computationally expensive 3D scenes common to many viewers, while the client-side module applies personalized text overlays, user-specific graphical elements, or localized content atop those base scenes. The compositing may utilize alpha channel transparency in the overlay elements, chroma keying to selectively replace portions of the underlying video, or other programmable blending modes.
The same multi-stage compositing workflow applies when starting from Static Segments 206. A static video segment may be retrieved from Storage 105, transmitted to User Device 101, and enhanced through client-side overlay rendering according to Rendering Engine Metadata 306, without requiring any server-side rendering. This approach minimizes server computational load for simple personalization tasks while maintaining the flexibility to add server-side rendering when needed for complex effects.
The decision to perform compositing server-side, client-side, or through a hybrid combination is made dynamically based on device capabilities, content requirements, licensing constraints, and optimization objectives, including but not limited to performance, energy efficiency, power consumption, cost, and environmental impact, as governed by the system's orchestration engine.
Optionally multiple Rendering Modules 117 are used to create the final output in concert, including a Rendering Module 119 present on the User Device 101. Both Rendered Video 305 and Rendering Engine Metadata 306 are being sent to the User Device 101. Rendering Engine Metadata 306 may or may not be in a completely different format that may or may not be proprietary, including instructions of how to render components on top of the received video segments 401. The same or similar workflow is also possible for Grab Static Segments 206 where the User Device 101 may dynamically render a new version using Rendering Module 119, using, optionally solely, Static Segments created on 206.
Storage 105 may also represent third-party services which may or may not create Static Segments in real-time or after a delay. For example, a service that generated a human avatar video, or text-to-speech audio. It may also represent third-party storage, e.g. of a third-party stock footage provider.
Many combinations and alternative workflows that are similar but not identical to the workflows shown in these figures may also be possible. The overall system is preferably able to optionally employ real time or just in time transcoding 118, and/or PTS/DTS adjustment 400, while still orchestrating the media delivery to the User Device 101 in a uniquely scalable way, by using a customized playlist 203, Rendering Engine Metadata 306, and streaming process 401.
According to at least some embodiments, Rendered Videos 305 may be intermediary. This means a server-side Rendering Module 117 or client-side Rendering Module 119 may need to use it as input for further processing or modification.
Optionally, multiple Rendering Modules 117 may be applied to create layered output, with server-side modules generating computationally expensive intermediate layers (such as 3D-rendered content common to multiple viewers) and client-side Rendering Module 119 applying personalized overlay layers based on Rendering Engine Metadata 306. The intermediate layers are cached and deduplicated using content hashes, for example.
The system preferably employs content-addressable storage for intermediate video layers, utilizing hash-based indexing to enable efficient retrieval and deduplication. When an intermediate layer is generated based on a specific set of EDL parameters, the system computes a hash value that uniquely identifies that variant. The hash function may be any suitable algorithm that produces sufficiently unique identifiers to make collisions extremely rare in practice, including but not limited to cryptographic hash functions such as SHA-256, SHA-512, MD5, or non-cryptographic hash functions optimized for speed such as xxHash or MurmurHash.
The hash may be calculated on various inputs depending on implementation requirements, including: (i) the raw intermediate content itself after rendering but before encoding; (ii) the encoded video stream comprising the intermediate layer; (iii) the specific EDL inputs and parameters that determine the intermediate's characteristics; or (iv) a combination thereof. In at least some embodiments, hashing the EDL inputs provides computational efficiency, as the hash can be computed before rendering to determine whether a matching intermediate already exists in cache. In other embodiments, hashing the encoded output ensures byte-level identical retrieval and serves as a content integrity verification mechanism.
When a request requires an intermediate layer, the system preferably first computes the hash based on the relevant parameters, queries the cache or storage using this hash as a key, and retrieves the existing intermediate if present. If no matching intermediate exists, the system then preferably generates the required content, computes its hash, and stores it indexed by that hash value for future reuse. This content-addressable approach ensures that identical intermediates generated from different requests or EDL configurations are automatically deduplicated, as they will produce identical hash values and reference the same stored content.
The rendering-metadata stream preferably comprises frame-accurate instructions specifying overlay compositions, effects parameters, and asset references required for client-side rendering. This metadata is synchronized with the video timeline and parsed by the client-side rendering module to apply personalized layers atop server-rendered content.
The system's orchestration logic selects rendering locations on a per-segment basis. Device capabilities are detected through passive fingerprinting (user agent analysis, hardware specifications) and active querying (GPU capabilities, available memory). Network conditions including bandwidth, latency, and jitter may optionally inform whether server-side pre-rendering or client-side just-in-time rendering will provide superior quality-of-experience.

### ADDITIONAL EMBODIMENTS AND CONSIDERATIONS

The present invention's flexibility and extensibility allow for various additional embodiments and considerations that further enhance its capabilities in delivering personalized video content. These aspects draw from the broader vision of creating video-first experiences throughout the customer journey. The below aspects are given as examples only and are not intended to be limiting in any way.

One exemplary extension of the system involves the integration of chat widget functionality. This feature enables the video player to seamlessly switch between text and video interfaces, where chat text could be transformed into video subtitles or captions. Such an implementation enhances user engagement by providing a more interactive and dynamic viewing experience.

The system can also be adapted to support full-screen playback as part of an immersive user interface experience. This mode can incorporate interactive elements, allowing users to navigate through different parts of the video, load alternative content, or even execute JavaScript functions. This level of interactivity transforms the viewing experience from passive consumption to active engagement.

Another powerful application of the technology is in content personalization and localization. The system can alter existing programs, such as TV shows or documentaries, to provide a tailored experience based on viewer characteristics. This includes accommodating disabilities (e.g., photosensitive epilepsy, hearing impairments) and sensitivities (e.g., PTSD triggers, violence, sexual content). Content creators can supply alternate scenes for specific parts of the content, which can be enabled or disabled in real-time based on user profiles.

In at least some embodiments, the present invention comprises the ability to support sophisticated product placement and native advertising within video content. This feature allows for the seamless integration of personalized promotional content into existing programs. The system can incorporate pre-produced segments or even generate content on-the-fly, such as adding generative text, image overlays, or personalized voice-overs using the protagonist's voice to promote specific businesses or products.

To address the challenge of content creation and authoring, the system can be integrated with a storyboard-like interface. This interface simplifies the process of creating and authoring content, allowing for the efficient conversion of raw media assets (or their “seeds,” like text inputs or prompts) into packages that can be used to provide personalized experiences for end-users.

In at least some embodiments, the architecture of the present invention is designed to handle multi-protocol support. While it leverages adaptive streaming protocols like HLS, MPEG-DASH, and CMAF, the technology can also be applied to other protocols, such as downloading multiple byte-ranges of an MP4 file. This flexibility ensures compatibility across a wide range of platforms and devices.

The present invention also preferably comprises a hybrid rendering capability. By intelligently distributing rendering tasks between client-side and server-side components, the system optimizes resource utilization, reduces server load, and enhances playback performance. This approach allows for real-time decision-making on where to perform specific rendering tasks based on factors such as client device capabilities, network conditions, and content complexity.

The system also incorporates advanced audio handling capabilities. Future developments may include the ability to mix multiple audio tracks dynamically, ensuring high-quality sound even when video content requires more or less music than is available. This could involve implementing cutting points or leveraging AI to create seamless audio transitions.

The present invention also preferably comprises a designed system and method that supports energy efficiency. By optimizing rendering processes, caching strategies, and distribution methods, the invention aims to minimize energy consumption while delivering high-quality, personalized video experiences. The system may dynamically balance server-side and client-side processing based on regional carbon intensity, aggregate power usage, and task frequency—for example, selecting client-side execution in low-carbon regions or for infrequent operations, while preferring server-side rendering when aggregate client-side energy use would exceed centralized processing costs. Such decisions may further account for performance targets, latency, and other operational objectives. This focus on efficiency not only reduces operational costs but also aligns with growing environmental concerns in the tech industry.

According to at least some embodiments, the system distinguishes between temporal stitching and spatial compositing operations when assembling personalized video content. Temporal stitching, as described elsewhere herein, combines multiple video clips sequentially along the timeline, producing a single continuous video stream whose duration usually equals the sum of the constituent clips' durations. Spatial compositing, by contrast, preferably combines multiple visual layers at the same point in time, rendering elements on top of base video content.

Overlay compositing in the system adds personalized or dynamic elements atop intermediate video layers, including but not limited to text overlays, graphical elements, images, animations, voice-over audio tracks, and interactive components. Overlays may utilize alpha channels to achieve partial transparency, allowing underlying video content to remain visible through transparent or semi-transparent regions of the overlay. Additionally or alternatively, the system may employ chroma keying techniques, wherein specific color values in either the overlay or underlying video are treated as transparent, enabling sophisticated compositing effects.

The compositing process is preferably programmable and configurable through the rendering metadata stream and EDL specifications. The system leverages existing industry-standard technologies and best practices for video compositing and layering, including but not limited to: alpha blending operations, porter-duff compositing modes, layer masks, blend modes (multiply, screen, overlay, etc.), z-ordering of multiple overlay layers, and time-synchronized rendering of overlays with frame-accurate precision.

Layer combination may occur at multiple points in the content delivery pipeline depending on system requirements and constraints. Server-side compositing generates fully-rendered composite video segments that are delivered as standard video streams to client devices, ensuring compatibility with simple playback clients and providing consistent quality across devices. Client-side compositing delivers separate base video and overlay instructions (via the rendering metadata stream) to capable client devices, which perform real-time composition during playback using browser APIs (such as HTML5 Canvas, WebGL, or CSS overlays), native video framework capabilities, or dedicated rendering engines, or playback software development kits (SDKs) integrated into applications or media players.

The decision of where to perform layer combination is preferably made dynamically by the system's orchestration logic based on multiple factors including: (i) client device capabilities (GPU availability, processing power, supported APIs), (ii) performance characteristics (available memory, thermal constraints, battery status for mobile devices), (iii) content licensing or digital rights management requirements that may mandate server-side rendering to protect certain assets, (iv) network conditions that may favor transmitting lightweight overlay instructions rather than fully-rendered composite video, and (v) personalization depth, wherein highly personalized overlays unique to individual viewers are preferentially rendered client-side while common intermediate layers are rendered server-side for caching efficiency, and (vi) energy-related or environmental considerations, including but not limited to regional carbon intensity, aggregate power consumption, or energy efficiency trade-offs between client-side and server-side processing.

In hybrid implementations, the system may perform multi-stage compositing, wherein a first compositing operation combines common layers server-side to create an intermediate render, and a second compositing operation adds personalized overlays client-side. This approach optimizes the tradeoff between server computational load, network bandwidth, cache efficiency, and personalization granularity.

The system preferably features a flexible deduplication architecture that operates across multiple scopes to optimize resource utilization. Deduplication may occur across different users viewing different programs, across different sessions for the same user, or both, depending on content characteristics and system configuration. This multi-scope deduplication capability enables the system to identify and reuse common intermediate renders regardless of whether the commonality stems from geographic targeting (multiple users in the same region seeing location-specific content), demographic segmentation (users in the same age group seeing age-appropriate variants), temporal factors (multiple viewers watching during the same promotional period), or any other content organization principle.

For example, regional promotional content rendered as an intermediate layer may be deduplicated and reused across thousands of users within that region, while user-specific overlays remain unique. Conversely, when a single user accesses content across multiple sessions, the system may deduplicate intermediates that depend only on user attributes (such as the user's name or account type) that remain constant across sessions, while regenerating intermediates that depend on time-sensitive data (such as current weather or latest promotional offers).

The deduplication mechanism preferably also supports anti-repetition policies, wherein the system tracks which intermediate variants have been presented to each user and biases selection toward unseen variants to maintain content freshness and user engagement. The hash-based content addressing enables efficient tracking: the system stores lists of previously-viewed intermediate hashes per user and excludes matching hashes when selecting content for subsequent sessions.

Without wishing to be limited in any way, the system's architecture preferably supports evolutionary optimization, enabling increasingly sophisticated deduplication strategies to be deployed without requiring fundamental architectural changes. Initial implementations may employ coarse-grained deduplication rules (such as ‘deduplicate all intermediates with identical EDL parameters’), while future enhancements may incorporate machine learning models that predict intermediate reuse likelihood and make intelligent decisions about when to generate cached intermediates versus rendering content on-demand per request.

In at least some embodiments, the system implements threshold-based intermediate generation, wherein an intermediate layer is created and cached only when predicted or observed reuse frequency exceeds a configured threshold. For example, if analytics indicate that a particular variant will be requested by fewer than N users (where N might be 5, 10, 100, or another value), the system may render that variant on-demand for each request rather than creating a cached intermediate. Conversely, high-reuse variants are proactively rendered as intermediates and cached for efficient serving.

The threshold determination may be static (configured by system administrators), dynamic (adjusted based on observed cache hit rates and rendering costs), or learned (predicted by machine learning models trained on historical usage patterns, content characteristics, and cost metrics). Machine learning approaches may analyze features including: EDL complexity, rendering computational cost, typical audience size for similar content segments, time-of-day patterns, seasonal trends, and correlations between user attributes and content popularity. The model outputs a predicted reuse count or reuse probability, which informs the decision to create an intermediate or render on-demand.

This flexible architecture allows the system to operate efficiently with simple rule-based policies in initial deployments, while supporting continuous improvement through increasingly sophisticated optimization algorithms. The core mechanisms of hash-based content addressing, metadata-driven rendering, and distributed cache management remain constant, providing a stable foundation for evolutionary enhancement of deduplication intelligence without fundamental redesign.

The system architecture is designed to support continuous improvement in resource efficiency through adaptive optimization strategies. While initial deployments may employ straightforward deduplication and caching policies, the underlying architecture provides the flexibility to incorporate increasingly sophisticated decision-making without requiring fundamental redesign.

In at least some embodiments, the system incorporates machine learning models that analyze historical rendering costs, cache hit rates, content request patterns, and user behavior to optimize intermediate generation decisions. These models may learn to predict which intermediate variants will achieve high reuse across multiple users or sessions, and which variants are so specific or ephemeral that on-demand rendering is more efficient than caching.

Training data for such models may include features describing: the EDL structure and complexity, rendering tool requirements (game engine vs. transcoder), estimated computational cost, historical request frequency for similar content, user population characteristics (geographic distribution, demographic attributes, viewing time patterns), content lifecycle (limited-time promotions vs. evergreen content), and observed cache performance metrics (hit rates, eviction frequency, storage costs).

The model outputs inform decisions including: whether to proactively render an intermediate or wait for first request, cache placement (origin storage vs. CDN edge nodes), cache priority for eviction policies, and replication factor across distributed cache infrastructure. As the system accumulates operational data, the models retrain periodically to adapt to changing content catalogs, user populations, and usage patterns.

This self-learning capability allows the system to begin operation with conservative, broadly-applicable policies (such as ‘cache all intermediates for at least 24 hours’ or ‘create intermediates for any content requested more than once’), and progressively refine those policies toward optimal resource utilization based on actual observed performance in the specific deployment environment. The architecture's flexibility ensures that enhanced optimization logic can be introduced incrementally without disrupting existing functionality or requiring migration of cached content.

Without wishing to be limited in any way, the system architecture as described herein supports a spectrum of implementation types, from simple baseline configurations to highly optimized advanced deployments. In basic implementations, the system may cache all generated intermediate layers regardless of predicted reuse, providing straightforward operation with consistently low latency and high cache hit rates at the cost of potentially higher storage utilization. This approach may be suitable for initial deployments, smaller content catalogs, or environments with abundant storage capacity, for example.

As deployments scale or as operational optimization becomes a priority, the system may be implemented so as to transition toward selective caching driven by automatic reuse prediction. Machine learning models trained on accumulated usage data identify which intermediate variants justify caching costs based on actual request patterns, enabling the system to allocate storage resources preferentially to high-value content while rendering low-reuse variants on-demand.

The exemplary two-layer architecture which may be employed, featuring a server-side intermediate layer and a client-side personalized layer, provides an effective balance for many use cases. The server-side layer captures computationally expensive rendering that benefits from centralized execution and cross-user deduplication, while the client-side layer handles lightweight personalization that varies per user and is efficiently executed on modern client devices. This division remains flexible: the server-side layer may range from simple static segment retrieval to complex multi-source rendering, and the client-side layer may range from trivial text overlays to sophisticated real-time effects, adapting to content requirements without architectural constraints.

Future enhancements may incorporate multi-layer server-side rendering with hierarchical caching, dynamic layer count optimization based on content analysis, predictive pre-rendering of anticipated high-demand variants, and distributed rendering coordination across edge nodes to balance computational load. For example, the hierarchical caching may feature a base layer, a regional layer, a demographic layer and a user-tier layer, in that hierarchical order. The mechanisms of hash-based content addressing, metadata-driven assembly, and flexible rendering orchestration as described herein support all these enhancements without requiring redesign of core system components.

These additional embodiments and considerations demonstrate the present invention's potential to revolutionize personalized video content delivery across various use cases, from marketing and advertising to customer support and entertainment.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for real-time creation and streaming of customized videos, comprising:
a decision engine configured to:
receive a request containing data parameters or contextual inputs;
analyze the data parameters or contextual inputs to determine relevant video segments;
generate an Edit Decision List (EDL) specifying a sequence of media components tailored to the request;
a rendering module configured to:
generate dynamic video segments in real-time based on the EDL;
incorporate live data into the dynamic video segments;
a streaming core configured to:
translate the EDL into instructions for assembling a video stream;
stitch together pre-rendered content and dynamically generated elements into a coherent video stream;
edge workers located at Content Delivery Network (CDN) nodes, configured to:
adjust Presentation Time Stamps (PTS) and Decoding Time Stamps (DTS) of cached video segments;
combine adjusted video segments into a seamless playback experience;
and wherein the system is configured to:
select between client-side and server-side rendering based on real-time assessment of client capabilities and network conditions; and
dynamically mix rendering strategies within a single video stream.

2. The system of claim 1, wherein the rendering module is further configured to utilize multiple rendering tools, including transcoders and game engines, to generate dynamic video segments.

3. The system of claim 1, wherein the live data incorporated into dynamic video segments includes at least one of: weather updates, location information, and current promotional offers.

4. The system of claim 1, further comprising a caching mechanism configured to:
store video segments at CDN nodes;
enable reuse of common elements across multiple requests;
reduce redundant processing and minimize latency.

5. The system of claim 4, wherein storing identifiers and hashes comprises:
computing a hash value for each intermediate video layer using a hash function selected to minimize collision probability;
indexing the intermediate video layer in storage using the computed hash value as a key; and
wherein the hash value is computed from at least one of: rendering parameters specified in the Edit Decision List, encoded video stream data of the intermediate layer, or raw rendered content before encoding.

6. The system of claim 4, wherein:
cache invalidation operates through lazy evaluation, such that changed inputs produce non-matching hash values during cache lookup rather than through active purge operations; and
cached intermediate video layers persist according to time-to-live (TTL) policies independent of whether corresponding Edit Decision List inputs have changed.

7. The system of claim 1, wherein:
the rendering module is configured to perform both temporal stitching of video segments and spatial compositing of overlay elements atop base video content;
temporal stitching combines video segments sequentially along a timeline; and
spatial compositing combines multiple visual or audio layers at overlapping time positions using programmable operations including alpha blending, chroma keying, or other compositing modes.

8. The system of claim 1, wherein the system dynamically selects between server-side compositing and client-side compositing based on at least one factor selected from: client device GPU capabilities, content licensing requirements, network bandwidth conditions, thermal or power constraints of the client device, and degree of personalization required.

9. The system of claim 1, further comprising a prediction module configured to:
estimate a reuse likelihood for intermediate video layers based on Edit Decision List parameters and historical usage patterns; and
determine whether to generate and cache an intermediate layer or render content on-demand based on the estimated reuse likelihood exceeding a threshold.

10. The system of claim 9, wherein the prediction module employs a machine learning model trained on features comprising at least one of: EDL complexity, rendering computational cost, historical request frequency, user population characteristics, content lifecycle attributes, or cache performance metrics.

11. The system of claim 9, wherein the system is further configured to:
track hash values of intermediate video layers previously presented to each user; and
bias selection of intermediate variants toward those not previously viewed by a requesting user to prevent repetition.

12. The system of claim 1, wherein the decision engine is configured to automatically determine, for each intermediate video layer, whether to generate and cache the intermediate layer or render content on-demand per request, based on predicted reuse analysis that estimates request frequency for the intermediate layer.

13. The system of claim 1, wherein base, intermediate, and overlay layers may be composited into a single adaptive streaming output compliant with standard streaming protocols, such that pre-rendered content and dynamically rendered elements are interleaved within a unified manifest or playlist while preserving synchronization metadata for bitrate switching.

14. The system of claim 1, wherein the system is further configured to perform just-in-time transcoding to ensure frame-accurate cuts and smooth transitions between segments.

15. The system of claim 1, wherein the decision engine is further configured to apply artificial intelligence-driven decision-making processes to determine relevant video segments.

16. A method for real-time creation and streaming of customized videos, comprising:
receiving a user request or a session (ID) request containing data parameters, which may include encrypted or otherwise protected values;
analyzing the data parameters to determine relevant video segments;
generating an Edit Decision List (EDL) specifying a sequence of media components tailored to the request;
generating dynamic video segments in real-time based on the EDL, including incorporating live data into the dynamic video segments;
translating the EDL into instructions for assembling a video stream;
stitching together pre-rendered content and dynamically generated elements into a coherent video stream;
wherein at Content Delivery Network (CDN) nodes the method comprise performing:
adjusting Presentation Time Stamps (PTS) and Decoding Time Stamps (DTS) of cached video segments;
combining adjusted video segments into a seamless playback experience;
selecting between client-side and server-side rendering, or both, based on real-time assessment of client capabilities and network conditions;
dynamically mixing rendering strategies within a single video stream.

17. The method of claim 16, further comprising utilizing multiple rendering tools, including transcoders and game engines, to generate dynamic video segments.

18. The method of claim 17, wherein the live data incorporated into dynamic video segments includes at least one of: weather updates, location information, and current promotional offers.

19. The method of claim 17, further comprising:
storing video segments at CDN nodes;
enabling reuse of common elements across multiple requests; and
reducing redundant processing and minimizing latency.

20. A non-transitory computer-readable storage medium storing instructions that, when executed by a processor, cause the processor to perform the method of claim 16.
